(19) United States
(12) Patent Application Publication
(10) Pub. No.: US 2022/0307903 A1
(43) Pub. Date: Sep. 29, 2022

(54) AN IMAGING SYSTEM AND A LIGHT ENCODING DEVICE THEREFOR

(71) Applicant: NATIONAL UNIVERSITY OF SINGAPORE, Singapore (SG)

(72) Inventors: Guangya ZHOU, Singapore (SG); Yu DU, Singapore (SG); Koon Lin CHEO, Singapore (SG); Fook Siong CHAU, Singapore (SG)

(21) Appl. No.: 17/616,924

(22) PCT Filed: Jul. 27, 2020
(86) PCT No.: PCT/SG2020/050430

§ 371 Date: Dec. 6, 2021

(30) Foreign Application Priority Data
Jul. 26, 2019 (SG) 10201906945W

(51) Int. Cl. G01J 3/28; G01J 3/18; G01J 3/02; G01J 3/06; G02B 26/08; G02B 27/46

(52) U.S. Cl. CPC G01J 3/2823; G01J 3/18; G01J 3/0208; G01J 3/06; G01J 3/0256; G01J 3/0229; G02B 26/0833; G02B 27/46; G01J 2003/1204

(57) ABSTRACT

A spectral imaging system comprises: a spatial encoder comprising a first light encoding device comprising a first mask for spatial encoding, the first mask being configured with one or more encoding patterns; a spectral encoder comprising: a dispersion arrangement for splitting spatially encoded light from the first light encoding device into a plurality of components; and a second light encoding device comprising a second mask for spectral encoding of the plurality of components, the second mask having one or more encoding patterns; and at least one single-pixel photodetector positioned to measure light that is encoded by the masks. The spatial encoder is operable to spatially encode light by generating a sequence of different patterns or partial patterns of the one or more encoding patterns of the first mask. The spectral encoder is operable to spectrally encode light by relative movement between the dispersion arrangement and the second mask.

### BACKGROUND

The present invention relates to an imaging system that includes one or more light encoding devices, such as a spectral imaging system.

Imaging has a wide range of applications, with a wide variety of imaging technologies having been developed for those applications.

Spectral imaging, for example, is an extremely useful tool and has found promising applications in biological science, health-care, agriculture, and defense systems. A line spectral imager acquires the spectra over a certain wavelength band for every resolvable point on a single spatial line. The result is a 2D intensity map, where the two axes are spatial (position) and spectral (wavelength or frequency), respectively. A spectral image data cube, i.e. a stack of images of a scene acquired in continuous bands over a wide spectral range, can be obtained through scanning the line imager along a direction perpendicular to that spatial line. With the spectral image data cube, it is thus possible to analyze the chemical composition or spectral signature for any object or point within the field of view (FOV), and color-render the image scene for presence or absence of certain materials based on established spectral libraries. As a result, spectral imagers capture information far beyond what is possible for traditional digital and infrared cameras. Potential applications of spectral imaging include mineral identification in geology, terrain classification and camouflaged target detection in defense systems, on-line inspection of food products, coastal and inland water studies, environmental hazards monitoring and tracking, and cancer detection in biomedical and life sciences.

The configurations for imaging can be broadly classified into three categories: (1) The whole field image is captured using a 2D array detector. (2) Successive line imaging using a one-dimensional (1D) array detector stepping through the whole image field along a direction perpendicular to the 1D array. (3) Utilizing a single-pixel detector and sequentially scanning through the image plane point by point.

In recent years, the use of a single-pixel photodetector for imaging applications has attracted much attention. One of the major reasons is that, although conventional silicon-based CCD or CMOS sensors are now ubiquitous and low-cost, imaging with arrayed photodetectors at wavelengths where silicon is blind, for example in infrared (IR) wavelengths, is considerably more complicated, bulky, and expensive. Hence, using a single-pixel-based photodetector in an imaging system not only significantly reduces cost, package size and weight but also enables the system to operate at wavelengths currently unavailable for conventional arrayed imagers. For spectral imaging applications, the single-pixel-based system may offer additional advantages, for example ease of calibration as it is inherently free of array uniformity errors.

Spectral imaging involves dispersing incoming light into its spectral constituents, allowing each spectral band's intensity to be picked up at separate detector elements to reconstruct its spectral profile. For such schemes, as the resolved spectral band gets narrower and frame rate increases, the lower the amount of radiation that is available to be picked up at the detector elements. The low intensity signals pose further challenges to the signal-to-noise ratio (SNR) at low energy IR wavelength ranges.

Multiplexing schemes have been proven to be an effective approach to increase the SNR through an inherent Fellgett's advantage. Such schemes, rather than viewing each spectral band individually, allow signals of multiple bands to be incident onto the detector simultaneously, and decouple the signals through post-signal processing. In this manner, such methods are viable in low-light conditions or when working at wavelengths that do not have sensitive detectors, such as in the infrared range. Spectral imaging is subject to such conditions, especially at high resolution and high frame rates.

The Hadamard transform underlies one such multiplexing scheme. Of particular interest is that such a scheme can be utilized for imaging with a single-pixel detector with high SNR. One implementation uses cyclic S-matrices, such that a weighted pattern is generated at the incoming image plane that allows or blocks designated points from reaching the single-pixel detector. Through a series of different patterns, the time-sequential signals from the detector can then be post-processed to reconstruct the image.

There have been various mechanisms proposed previously for generating mask patterns for Hadamard multiplexing. There are, in general, two ways of modulating a two-dimensional image field. The first is to use two orthogonal 1D pattern masks and the second is to employ a single 2D pattern mask.

Using two 1D masks is generally easier to implement and simpler to actuate but results in a greater attenuation loss, as each mask permits roughly 50% of the total incident radiation to pass through. Each 1D mask is made up of openings arranged in a Hadamard pattern to modulate the image field in a single direction. Two 1D masks are arranged in an orthogonal manner so that each direction is modulated by each mask independently of the other. The actuation necessary for each mask is considered simple because each mask needs only to be moved linearly.

2D masks, on the other hand, have the benefit of allowing greater overall radiation to reach the detector but require a more complex actuation mechanism to move the patterns. There are two ways of arranging the mask patterns to accomplish this 2D encoding. In one method, all the required mask patterns are folded into a large 2D array. The actuation mechanism would then have to step through and move the mask two-dimensionally to generate all the Hadamard encoding patterns. Such a mechanism would be potentially complex to execute. Another way would be to line up all the necessary 2D patterns linearly. Actuation would then only require a single direction of movement but with significantly increased traveling range. Rotating drums, spinning wheels and micro-slits of 2D patterns are mechanisms that have been used to generate the 2D patterns. Other known variations may include multiple detectors.

Among other disadvantages of existing systems as mentioned above, existing imaging systems that use Hadamard multiplexing are large and limited in frame rate, as they rely on components such as electric motors and stages to actuate the mask patterns.

It is generally desirable to overcome or ameliorate one or more of the above described difficulties, or to at least provide a useful alternative.

### SUMMARY

The present invention provides a spectral imaging system comprising:
a spatial encoder comprising a first light encoding device comprising a first mask for spatial encoding, the first mask being configured with one or more encoding patterns;
a spectral encoder comprising:
a dispersion arrangement for splitting spatially encoded light from the first light encoding device into a plurality of components; and
a second light encoding device comprising a second mask for spectral encoding of the plurality of components, the second mask having one or more encoding patterns; and
at least one single-pixel photodetector positioned to measure light that is encoded by the masks;
wherein the spatial encoder is operable to spatially encode light by generating a sequence of different patterns or partial patterns of the one or more encoding patterns of the first mask; and
wherein the spectral encoder is operable to spectrally encode light by relative movement between the dispersion arrangement and the second mask.

In some embodiments, the spatial encoder comprises a window structure comprising at least one aperture that is positionable in line with the first light encoding device to selectively expose at least part of the one or more encoding patterns of the first mask, and the first mask is movable relative to the at least one aperture in oscillatory fashion.

In some embodiments, the at least one aperture is also positionable in line with the second light encoding device to selectively expose at least part of the one or more encoding patterns of the second mask, and the second mask is movable relative to the at least one aperture in oscillatory fashion.

In some embodiments, the first light encoding device is a light encoding device as disclosed herein, and/or the second light encoding device is a light encoding device as disclosed herein.

In some embodiments, the first mask is a dynamic mask that is operable to generate said sequence of different patterns. For example, the dynamic mask may comprise a MEMS programmable slit or a digital micromirror device.

In some embodiments, the dispersion arrangement comprises a diffraction grating that is configured for oscillatory rotation, or a fixed-position diffraction grating that is optically coupled to a scanning mirror that is configured for oscillatory rotation.

In some embodiments, the imaging system or the spectral imaging system may comprise a plurality of single-pixel photodetectors, and at least one mask may comprise a plurality of zones, respective zones being associated with respective ones of the plurality of single-pixel photodetectors.

The present invention also provides a light encoding device for generating an encoding pattern for an imaging process, the light encoding device including:
one or more oscillators; and
a mask coupled to the one or more oscillators, the mask having one or more patterns each comprising opaque and transparent sections;
wherein the one or more oscillators are operable to move the mask across an aperture to selectively expose at least part of said one or more patterns through the aperture to thereby generate the encoding pattern.

In some embodiments, a first oscillator of the one or more oscillators is coupled to a second oscillator of the one or more oscillators by an auxiliary mass.

The light encoding device may be configured to receive a driving force in a direction substantially parallel to an oscillation direction of at least one of the one or more oscillators, and/or in a direction substantially perpendicular to an oscillation direction of at least one of the one or more oscillators.

The mask of the light encoding device may comprise a plurality of patterns. For example, the mask may be a Hadamard mask.

In some embodiments, the one or more oscillators are coupled to one or more respective support structures, at least one of which may be fixed.

In some embodiments, at least one of the oscillators is coupled to a gimbal, the gimbal being coupled to a gimbal suspension oscillator.

In some embodiments, the mask is coupled to a first pair of opposed oscillators configured to oscillate in a first direction, and a second pair of opposed oscillators configured to oscillate in a second direction that is orthogonal to the first direction.

In some embodiments, the light encoding device is a substantially planar structure, and may be a MEMS device, for example.

The present invention also provides an imaging system, comprising:
one or more light encoding devices as disclosed herein;
a window structure comprising at least one aperture that is positionable in line with the one or more light encoding devices to selectively expose at least part of the one or more patterns of the mask or masks, the window structure also being positionable in line with an object or a light source;
one or more actuators to cause the mask or masks to move across the at least one aperture; and
at least one single-pixel photodetector positioned to measure light from the object or the light source that is encoded by, and transmitted through, the mask or masks.

The imaging system may comprise one or more position sensors to monitor a position of the mask, or respective positions of the masks.

### BRIEF DESCRIPTION OF THE DRAWINGS

Some embodiments of the invention are hereafter described, by way of non-limiting example only, with reference to the accompanying drawings in which:

FIG. 1 is a schematic diagram showing the operational principle of a light encoding device that includes a Hadamard mask;

FIG. 2 is a schematic diagram showing a first configuration of a Hadamard mask and a rectangular window;

FIG. 3 is a schematic diagram showing a second configuration of a Hadamard mask and a rectangular window;

FIG. 4 is a schematic diagram showing the operational principle of the encoding mechanism implemented by certain embodiments;

FIG. 5 is a schematic diagram showing a direct single DOF driving scheme for a 1D Hadamard mask;

FIG. 6 is a schematic diagram showing an alternative single DOF driving scheme for a 1D Hadamard mask;

FIG. 7 is a schematic diagram showing another alternative single DOF driving scheme for a 1D Hadamard mask;

FIG. 8 is a schematic diagram showing one possible actuation mechanism for a 1D Hadamard mask with a 2-DOF system;

FIG. 9 is a schematic diagram showing an alternative to the actuation mechanism shown in FIG. 8;

FIG. 10 is a schematic diagram of an electrostatic comb drive actuated Hadamard mask device showing a possible implementation of the mechanism of FIG. 5;

FIG. 11 is a schematic diagram of an electromagnetic actuated Hadamard mask device showing another possible implementation of the mechanism of FIG. 5;

FIG. 12 is a schematic diagram of an electrostatic comb drive actuated Hadamard mask device showing a possible implementation of the mechanism of FIG. 8;

FIG. 13 is a schematic diagram of an electromagnetic actuated Hadamard mask device showing another possible implementation of the mechanism of FIG. 8;

FIG. 14 is a schematic diagram showing generation of 2D Hadamard encoding patterns using (a) two orthogonally scanning 1D masks and (b) a single 2D Hadamard mask scanning in two directions;

FIG. 15 is a schematic diagram of a 2D Hadamard mask driving mechanism using a gimbal-like structure;

FIG. 16 is a schematic diagram of a 2D Hadamard mask driving mechanism using a gimbal-less structure;

FIG. 17 is a schematic diagram of a miniaturized Hadamard transform spectrometer;

FIG. 18 is a schematic diagram showing a Hadamard mask fabricated in accordance with the configuration in FIG. 3;

FIG. 19 shows photographs of an electromagnetic actuated Hadamard mask device fabricated in accordance with the configuration in FIG. 8, and its associated rectangular window;

FIG. 20 is a graph of the reconstructed spectra for red, green and blue LEDs;

FIG. 21 is a schematic diagram of a miniaturized Hadamard transform 2D imaging system;

FIG. 22 is a block diagram showing a spectral line imager realized by (a) encoding-dispersion-encoding configuration with two 1D Hadamard pattern generators and (b) dispersion-encoding configuration with one 2D Hadamard pattern generator;

FIG. 23 is a schematic diagram of a miniaturized Hadamard transform line spectral imaging system;

FIG. 24 is a schematic diagram of a miniaturized Hadamard transform endoscopic imaging system using two 1D Hadamard encoders;

FIG. 25 is a schematic diagram of a miniaturized Hadamard transform endoscopic imaging system using a single 2D Hadamard encoder;

FIGS. 26(a) and 26(b) are schematic diagrams illustrating the underlying working principle of a method for matching window and photodetector sizes;

FIG. 27 shows a schematic diagram of a system for enhancing image resolution using cascaded Hadamard masks;

FIG. 28 shows a method for achieving high resolution using cascaded Hadamard masks with non-overlapping detection zones for the first configuration for 1D imaging shown in FIG. 2;

FIG. 29 shows a method for achieving high resolution using cascaded Hadamard masks with overlapping detection zones for the first configuration for 1D imaging shown in FIG. 2;

FIG. 30 shows a method for achieving high resolution using cascaded Hadamard masks for the second configuration for 1D imaging shown in FIG. 3, with two different forms that use (a) non-overlapping and (b) overlapping detection zones;

FIG. 31 shows an example of a spectral/hyperspectral imaging system using a moving encoder for spatial encoding and a scanner with a fixed Hadamard encoder for spectral encoding;

FIG. 32 shows an example laboratory scale implementation of the example shown in FIG. 31; (a) shows an optomechanical layout of the system with ray-tracing diagrams, and (b) is a photo showing the setup;

FIG. 33 shows experimental results obtained with the system shown in FIG. 32; in (a) and (b), the captured hyperspectral image is shown on the left side and the photo of the target is shown on the right side;

FIG. 34 shows an example of a spectral/hyperspectral imaging system using a MEMS programmable slit for spatial encoding and a scanner with a fixed Hadamard encoder for spectral encoding;

FIG. 35 shows a schematic of the synchronization scheme used for the example shown in FIG. 34;

FIG. 36 shows an example of a spectral/hyperspectral imager in which spatial and spectral encoding schemes are integrated in one system;

FIG. 37 shows another example of a spectral/hyperspectral imager in which spatial and spectral encoding schemes are integrated in one system;

FIG. 38 shows a further example of a spectral/hyperspectral imager in which spatial and spectral encoding schemes are integrated in one system;

FIG. 39 shows an example implementation of the example shown in FIG. 37;

FIG. 40 is a photo of the experimental setup of the hyperspectral imaging system shown in FIG. 39;

FIG. 41 shows experimental results obtained using the hyperspectral imaging system shown in FIG. 40; and

FIG. 42 shows an example imaging configuration that enables expansion of the operational spectral band to multi-octave using a cascading scheme in the spectral dimension.

### DETAILED DESCRIPTION

In general terms, the present disclosure relates to light encoding devices including miniaturized 1D and 2D encoding pattern generators and their uses in imaging systems, such as spectral imaging systems. The use of light encoding devices according to embodiments enables imaging to be performed using single-pixel or few-pixel detectors, whereby a sequence of measurements made with different respective encodings may be used to reconstruct an image using a suitable reconstruction algorithm, such as a Hadamard transform-based reconstruction algorithm, compressive sensing, or a deep learning-based algorithm.

While embodiments will be described in detail below with reference to light encoding devices that make use of Hadamard encoding, it will be appreciated that the invention may be adapted for use with other types of encoding pattern generator. For example, some types of encoding pattern generator may use random patterns.

Embodiments relate to miniature mechanisms to generate one-dimensional or two-dimensional sequential, time-varying encoding patterns used for imaging. Embodiments also relate to how to combine multiple encoding patterns to achieve high imaging performance. The encoding patterns can be Hadamard patterns or random patterns. The image reconstruction algorithms can be a Hadamard transform, compressive sensing, deep-learning, and many others.

Imaging systems according to embodiments generally comprise a light encoding device comprising at least one mask having one or more patterns each of which comprises opaque and transparent sections to selectively transmit light to a detector according to the one or more patterns. A window structure having at least one aperture is provided in alignment with the light encoding device, such that when the at least one mask is caused to oscillate, different spatial regions of the at least one mask (and thus the pattern encoded in the at least one mask) are visible through the aperture, such that time-varying signals measured by the detector can be used to reconstruct an image of a source object that is within the field of view of the detector.

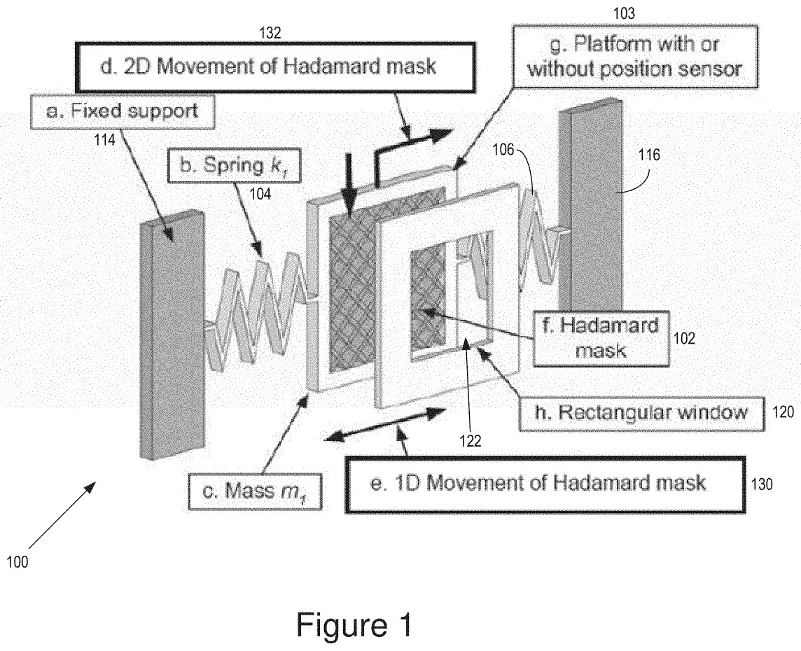

A first example of a light encoding device 100 will now be described with reference to FIG. 1. The light encoding device 100 comprises an encoding mask 102 that is a Hadamard mask. The Hadamard mask 102 has a pattern that selectively passes the light from designated pixels to enter an imaging system. The Hadamard mask 102 is supported by a movable mass platform 103 that encodes the incoming radiation corresponding to a cyclic S-matrix of certain size. The Hadamard mask 102 can be moved one dimensionally in the direction indicated at 130, or two dimensionally as indicated at 132, with respect to a rectangular window 120 to generate all possible encoding patterns inside the aperture 122 of the rectangular window 120. The rectangular window 120 can be anchored to the same support as the Hadamard mask 102 or to a separate support, with a small gap between the window 120 and the mask 102. At any one time, only a selected Hadamard pattern is viewable through the window opening 122. After the radiation passing through one encoding pattern has been measured, the encoding pattern is replaced with another by moving the Hadamard mask 102 relative to the window 120. A set of Hadamard patterns is completed by moving the Hadamard mask 102 through all designated positions.

The platform 103 that supports the Hadamard mask 102 is coupled at a first side to a first oscillator in the form of a spring structure 104, which is in turn connected to a fixed support 114. Platform 103 may also be coupled at a second side, opposite the first side, to a second oscillator in the form of a spring structure 106, that is in turn connected to a fixed support 116. Spring structures 104, 106 allow the platform 103 and thus the Hadamard mask 102 to be driven in an oscillatory motion to take advantage of resonant amplification to achieve large-amplitude, high-speed, and low-power operation. In the embodiment shown in FIG. 1 the spring structures 104, 106 oscillate in the same direction but it will be appreciated that spring structures oscillating in orthogonal directions may be provided, as will be explained in relation to some other embodiments.

It is to be noted that the oscillators (spring structures) 104, 106 in FIG. 1 are shown in schematic form only, and that in practice may take many different forms. For example, in a MEMS-based coding aperture device, the spring structures may be planar structures such as flexure springs and the like.

In some embodiments, the light encoding device 100 can comprise a position sensor for feedback and/or for triggering data acquisition. For example, the position sensor may be a piezoresistive sensor, a capacitive sensor, an optical encoder, and the like.

The following description of exemplary light encoding devices and imaging systems refers to the generation of Hadamard encoding patterns and their use in various imaging applications, including as part of miniature spectrometers and spectral imagers. Adaptation of such systems to other encoding pattern generators and their corresponding image reconstruction algorithms will be readily apparent to those skilled in the art.

Embodiments of the invention concern the miniaturization of 1D and 2D Hadamard-transform pattern generators and the applications of these pattern generators in various imaging systems. As mentioned above, previously known arrangements are large and limited in frame rate as some form of macro electric motors and stages are needed to actuate the mask patterns.

Embodiments of the present invention provide miniaturized mechanisms for encoding incoming radiation through the use of the Hadamard transform to generate complete sets of 1D and/or 2D Hadamard encoding patterns to modulate the image field. Embodiments of the present invention also relate to the use of such mechanisms in various imaging systems. Embodiments of the present invention further disclose the method of cascading a plurality of such mechanisms for enhancing the performance of an imaging system. The mask together with its driving mechanisms may be fabricated utilizing microelectromechanical systems (MEMS) technology.

The mask 102 may comprise a transparent material which has been opacified to produce the desired encoding pattern of opaque and transparent regions (pixels), or may comprise an opaque material in which transparent regions are formed in the desired encoding pattern. For example, the transparent regions may be formed as apertures in the opaque material. In other embodiments, the mask 102 may comprise a transparent material with an opaque coating which is then selectively removed in the desired encoding pattern. The transparent regions may be microstructured, and may be formed by laser ablation, etching, or other microstructuring techniques.

In some embodiments, an encoding mask may comprise reflective regions rather than transmissive regions. For example, a mask may comprise an array of micromirrors having facets which are arranged in the desired encoding pattern, with at least some facets (pixels) being in an “on” orientation such that incident light is reflected in a manner to be able to be received by downstream optical components (such as a diffraction grating or a second mask), and other facets being in an “off” or dark orientation such that incident light is reflected away from such downstream components. In some embodiments the mask may cooperate with an absorber, whereby light incident on the “off” facets is reflected to, and absorbed by, the absorber. The array of micromirrors may be fixed with the desired encoding pattern or may be MEMS-actuatable to apply and/or vary the desired encoding pattern.

The platform 103 may be actuated in periodic motions one-dimensionally or two-dimensionally. When the mask 102 is moved through the complete range, a complete set of cyclical encoding patterns is generated. Combining the light encoding device 100 with an optical imaging system, various types of images can be obtained with single-pixel-based photodetectors. Images are typically obtained through a digital reconstruction process. The image reconstruction algorithms can be based on the Hadamard transform, compressive sensing, deep-learning, and many others.

To increase the travel range of the microstructures of mask 102 so as to enlarge the imager's field-of-view (FOV), or to enhance the number of pixels in the captured images, a displacement amplification mechanism may be incorporated into the mechanical structural design of the light encoding device 100.

To further enhance the imaging performance, for example by enlarging the FOV, increasing the number of pixels, and/or increasing the frame rate, multiple miniature light encoding devices 100 coupled with multiple single-pixel-based photodetectors can be incorporated into an imaging optical system. A positioning sensing mechanism may be built into the structure 100 to trigger data sampling for reconstruction of the images.

A microfabrication process can be employed to implement a miniaturized system for a number of advantages including low-cost, light-weight, and high-speed operation. The micro-structures, actuation mechanism, positioning sensing units, and flexure suspension springs can be all fabricated in a single structural device, greatly simplifying the alignment and assembly processes.

Some further examples of light encoding devices and imaging systems in which they are employed will now be described.

### One-Dimensional (1D) Hadamard Encoding

In some embodiments of the invention, for 1D Hadamard encoding, two configurations are possible in arranging Hadamard mask patterns on a Hadamard mask device.

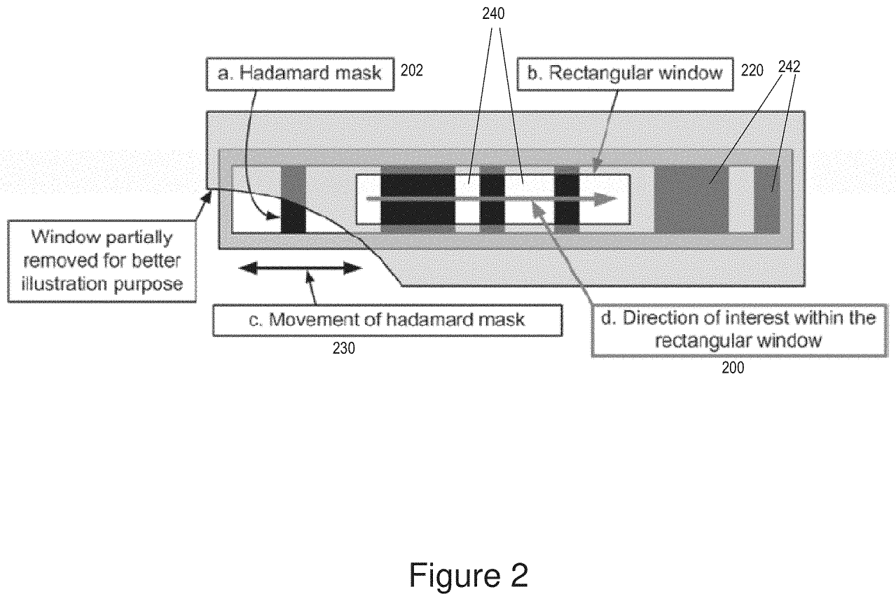

For example, in a first configuration as shown in FIG. 2, a single line of cyclical Hadamard patterns is provided in a Hadamard mask 202. The Hadamard mask 202 has a number of open 240 and closed 242 elements. A rectangular window 220 is aligned such that a partial number of the encoded elements 240, 242 are viewable through it. The direction of interest 200, which is the direction along which it is desired to measure the radiation intensity distribution, is along the line of the Hadamard patterns which also corresponds to the direction of movement 230 of the Hadamard mask 202. The Hadamard mask 202 is moved thereby changing the Hadamard pattern viewable through the window 220.

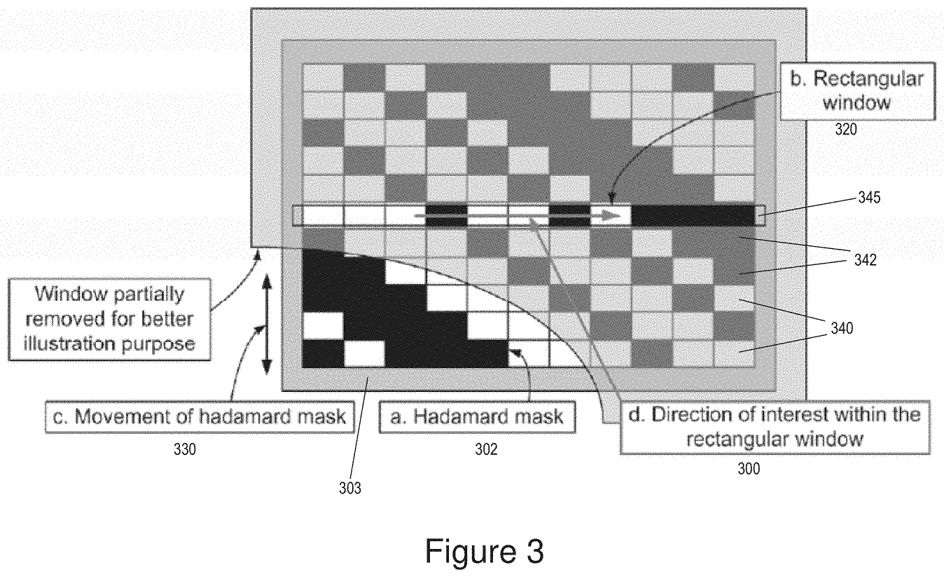

In a second configuration as shown in FIG. 3, the Hadamard mask 302 is moved perpendicularly (as indicated at 330) to the direction of interest 300. The Hadamard mask 302 is supported by a platform 303 and has a number of open 340 and closed 342 elements that are arranged in a two-dimensional grid. The Hadamard mask 302 elements 340, 342 are arranged such that the rectangular window 320 exposes, at any given time, a single line (e.g. line 345) of elements, which corresponds to a single Hadamard pattern. The Hadamard mask 302 comprises multiple lines of elements 340, 342; each forms a single Hadamard encoding pattern. The lines of elements 340, 342 collectively provide a complete set of Hadamard encoding patterns. Each line 345 of elements is exposed one after another by the rectangular window 320 as the Hadamard mask 302 is moved.

Both configurations allow for an open-loop operation without a feedback mechanism. Pre-calibration can be done to ascertain the position of the Hadamard mask 202 or 302 during operation. Both configurations also allow for a closed-loop operation, where position sensing mechanisms can be incorporated.

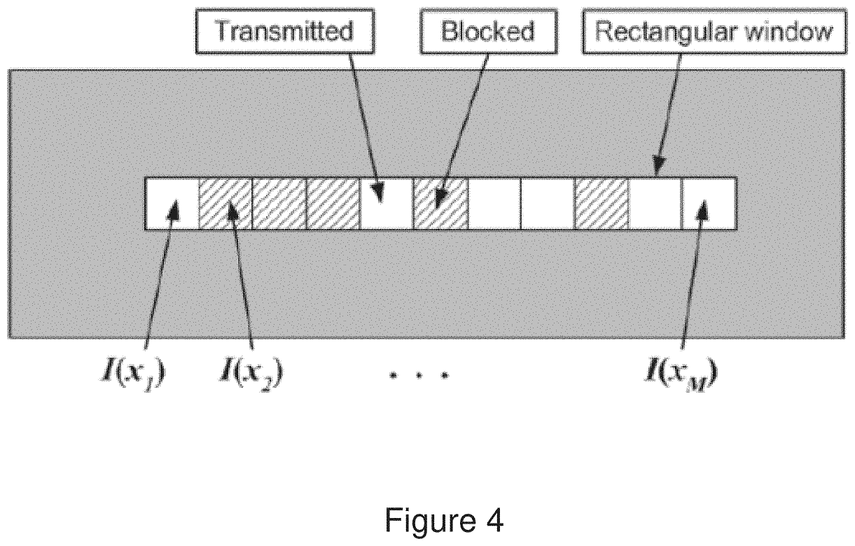

The operational principle of the encoding mechanism is as follows, referring again to FIG. 1. The Hadamard mask 102 is in the i^{th} configuration (i=1, 2, . . . , M) to encode the radiation passing through the window 120 with the resultant encoded radiation being collected by a detector. The Hadamard mask is then moved to the next position, and the process is repeated until all the M measurements are done. Mathematically as shown in FIG. 4, this can be expressed as:

$${m}_{i} = {\sum }_{j = 1}^{M} {a}_{ij} I ( {x}_{j} ) \qquad ( 1 )$$

where mᵢ is the i^{th} measured intensity signal, I(xⱼ) is the radiation intensity at a position xⱼ (j=1, 2, . . . , M) in the window 120, aᵢⱼ is the attenuation at position xⱼ according to the Hadamard mask setting at the i^{th} configuration. The values of aᵢⱼ are either 1 or 0, corresponding to passing or blocking conditions of the Hadamard masking patterns, respectively. Equivalently, Eq. (1) may be rewritten in a single matrix equation:

M=AI (2)

with the matrices M=[mᵢ], A=[aᵢⱼ] and I=[Iⱼ]=I(xⱼ). Consequently, the line image I(xⱼ), i.e. the intensity distribution can be reconstructed by:

I=A⁻¹M (3)

The step motions of the Hadamard slit mask may also be replaced with continuous scanning motions to scan through the window.

Actuation of the 1D Hadamard mask device 202, 302 shown in FIG. 2 and FIG. 3 to change the pattern visible through the window 220, 320 can generally be achieved in two ways.

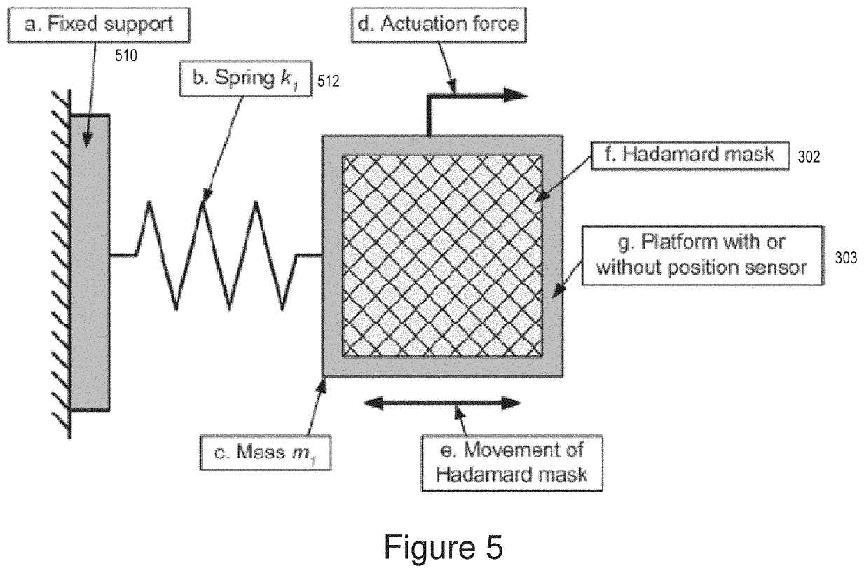

In one possible implementation, as shown in FIG. 5, a single degree-of-freedom (DOF) spring-mass mechanism may be employed. For example, the platform 303 that supports Hadamard mask 302 may be coupled to a spring 512 that is connected to a support 510. An actuation force can be applied directly to the platform 303. The single DOF spring-mass system is characterized by k₁ and m₁ where k₁ is due to the spring structure 512 and m₁ is the mass of the platform 303. Many forms of periodic motions (for example sinusoidal, sawtooth, and triangular) are possible. In some embodiments, the platform 303 may be moved in a sinusoidal oscillatory fashion for high frequency and large amplitude operation. When the frequency of the actuation force matches the natural frequency of the 1-DOF system, a large vibration amplitude results, which is highly beneficial for large FOV or high resolution imaging. As the motion of the Hadamard mask 302 in this case is sinusoidal, position sensors (piezoresistive, capacitive, optical encoder etc.) may be integrated on the moving platform 303 to trigger data sampling at correct Hadamard encoding configurations (i.e., positions at which a specific encoding pattern 345 is visible within window 320).

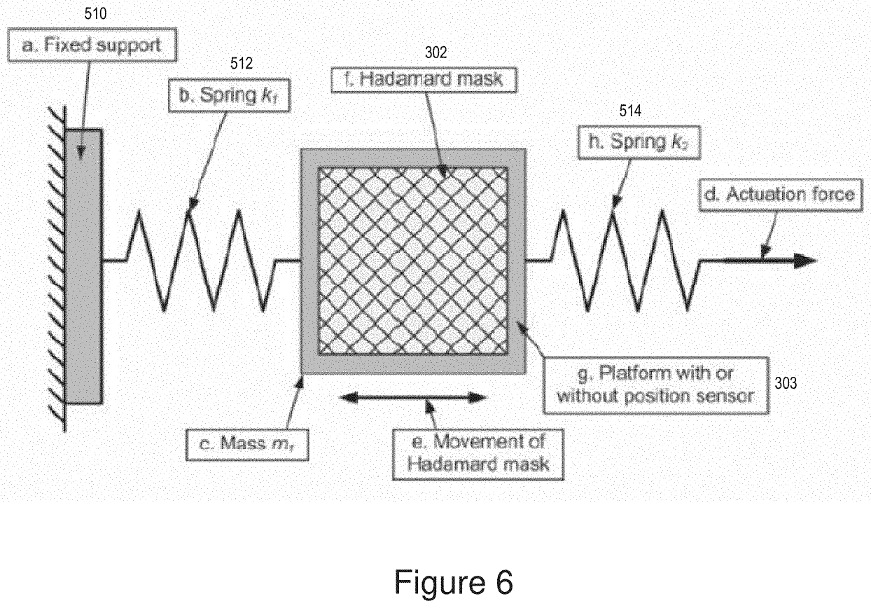

Other ways of actuating a single DOF spring-mass mechanism with Hadamard mask 302 integrated on the mass platform 303 are also possible. For example, in FIG. 6, the actuation force is applied to the platform 303 through a second spring 514 having spring constant k₂. In this case, the system's natural frequency is determined by the mass and a combination of two springs 512 (having spring constant k₁) and 514 (having spring constant k₂).

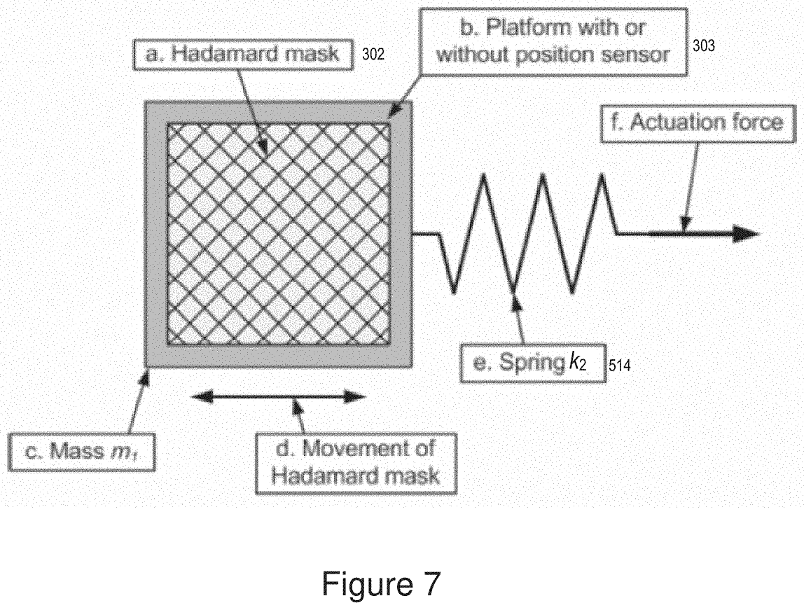

The configuration of FIG. 6 may be modified by removing the fixed support 510 and the spring 512 connecting the platform 303 to the fixed support 510. This provides yet another driving scheme as shown in FIG. 7. In this case, the actuation force can also drive the platform 303 into a vibratory motion, and the system's natural frequency is determined by the mass m₁ and spring 514.

In a second configuration for 1D Hadamard mask actuation, a 2-DOF spring-mass mechanism may be utilised. The advantages of using such a mechanism can be explained as follows. Microactuators typically have a limited maximum displacement/stroke of a few tens of micrometers. For example, the maximum stroke of an electrostatic combdrive microactuator is limited by the electrostatic pulling phenomenon. Consequently, the stroke limitation of the microactuators may result in low resolution and small FOV of an optical imaging system using the Hadamard encoding technology. To overcome this limitation, some form of vibration amplitude amplification mechanism is very useful, especially for higher resolution and larger FOV applications. One way to achieve this amplification is through indirect actuation of the light encoding device through a 2-DOF spring-mass mechanism. Such mechanism typically has two vibrating modes at two distinct frequencies. When operated at a selected frequency, large vibration amplitude of the Hadamard mask can be achieved.

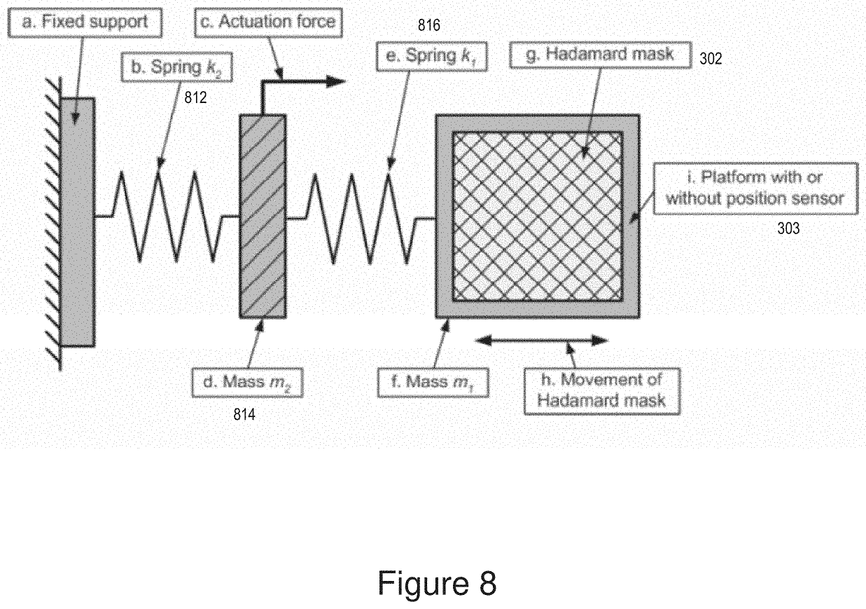

FIG. 8 shows one example of the 1D Hadamard mask driving scheme involving a 2-DOF spring-mass mechanism. As shown in the figure, the actuation force acts upon an additional spring (812) and mass (814) structure k₂-m₂ (primary driving system). In combination with the secondary responding system, namely the platform 303 having a mass m₁ carrying the Hadamard mask 302 and the suspension spring 816 having spring constant k₁, this essentially results in a classic mechanical 2-DOF system with two vibration modes at two different frequencies. Generally, by designing the mass and spring ratios of the primary and secondary systems, and driving the micro device at a desirable vibration mode, large oscillatory amplitude of the second responding system (the Hadamard mask 302) can be achieved while maintaining a small vibration amplitude of the primary driving system (the microactuator). This substantially obviates the stroke limitation of using microactuators.

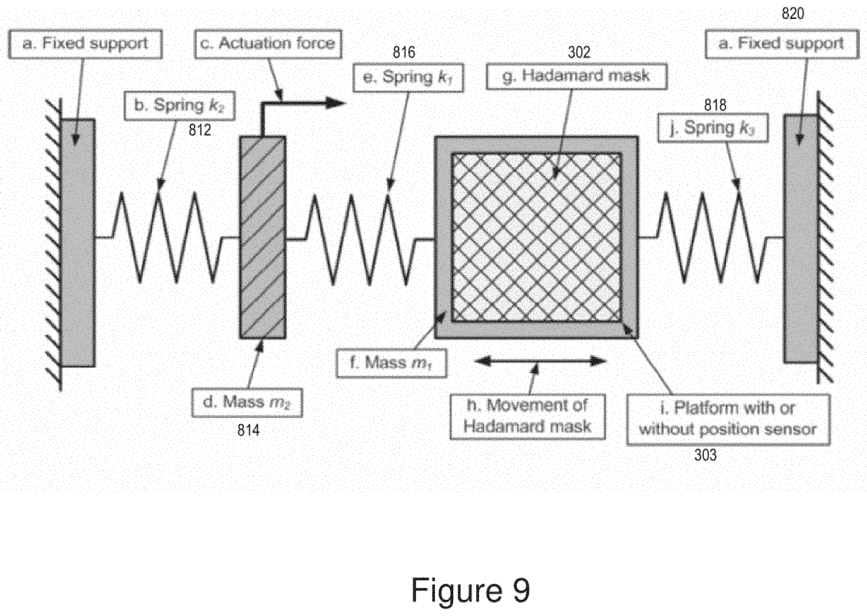

Variations of driving schemes utilizing a 2-DOF spring-mass mechanism for displacement amplification are possible, for example the one shown in FIG. 9. In this case, an additional spring 818 having spring constant k₃ is used to connect the platform 303 and a second fixed support 820. In this embodiment, the primary driving system comprises the spring 812 having spring constant k₂, and the mass m₂ 814, and the secondary responding system comprises the mass m₁ (of platform 303) and springs 816 (k₁) and 818 (k₃).

It is noted that many variations of the springs and masses described in this disclosure are possible. For example, in practical implementations, a spring can take any form and can comprise multiple flexures connected in any pattern. The springs and masses disclosed herein are one possible form of oscillator suitable for implementing embodiments of the invention. It will be appreciated that many other types of oscillator may also be employed.

Conventional ways of moving the Hadamard masks are using electrical rotational, linear, or step motors, which result in a bulky imaging system with a slow image acquisition rate. Accordingly, embodiments of the invention are directed to a miniaturized system that employs micromachined structures that can substantially enhance the image acquisition rate. It also facilitates the miniaturization through integration of a Hadamard pattern, spring suspension, and driving actuator on a common-chip platform utilizing microelectromechanical systems (MEMS) technology. The advantages include small form-factor, light weight, high operation speed, low power consumption, and low cost. In embodiments of the invention, the micro devices having Hadamard patterns are driven in oscillatory motions to scan the image field. The device can be operated at its natural frequency to take advantage of resonant displacement amplification to achieve large scan amplitude while maintaining high-speed operation and low-power operation at the same time.

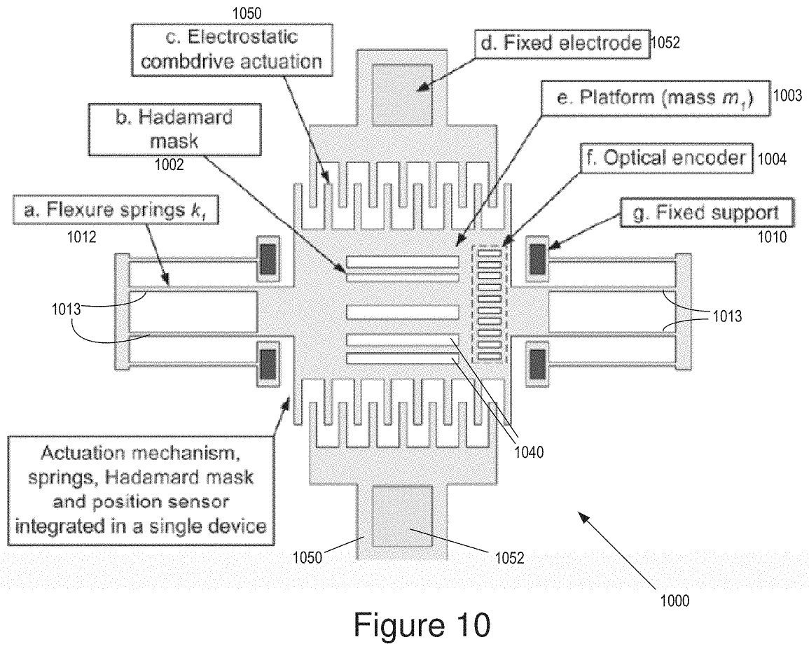

Example realisations of light encoding devices manufacturable by MEMS techniques will now be described with reference to FIGS. 10 to 13.

The light encoding device 1000 shown in FIG. 10 follows the concept of the single DOF driving scheme shown in FIG. 5. Light encoding device 1000 may be formed as a substantially planar structure that comprises a Hadamard mask pattern 1002 that may be fabricated by forming a series of micro-sized structures or openings 1040 in a sheet or layer of an opaque material. That creates a series of areas that blocks incident radiation from passing through and the absence of them allows radiation to pass through.

A platform 1003 that carries the mask structure 1002 is held in place through elastic beams 1013 that act as springs 1012. The springs 1012 are fixed in space through supporting anchors 1010. This creates a classical mechanical spring-mass system that can be actuated in resonance. The structure can be actuated by, for example, electrostatic combdrive structures 1050 that are in communication with electrodes 1052. The mask 1002 oscillates when actuated, and in combination with a window device (not shown), such as the window 120 shown in FIG. 1, generates a series of Hadamard encoding patterns. Notably, all of the structures of the device 1000 can be fabricated in integrated form in a single device. They can also be fabricated separately and integrated together through an assembly process. An additional optical encoder 1004 may be incorporated on the device 1000 as a feedback positioning tool. Other feedback mechanisms like piezoresistive, capacitive etc. are also possible in some implementations.

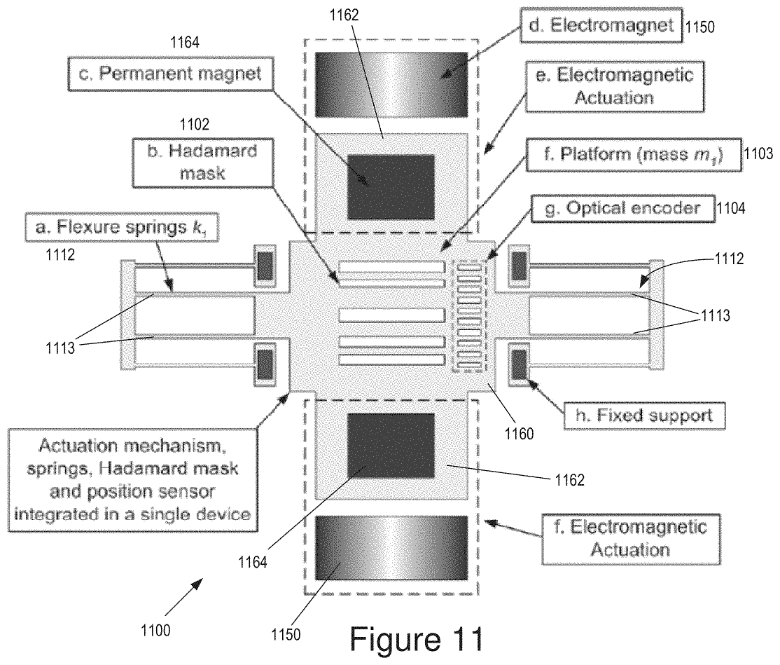

In some embodiments, a light encoding device can be electromagnetically driven. For example, as shown in FIG. 11, a light encoding device 1100 comprises a Hadamard mask 1102 carried on a platform 1103 that is coupled to a flexure spring 1112 formed by beams 1113 that extend between platform 1103 and fixed supports 1110. The platform 1103 has a central portion 1160 in which the Hadamard mask 1102 is located, and side portions 1162 either side of the central portion 1160, each of which carries a permanent magnet 1164. An external electromagnet 1150 may be used to actuate the device 1100. The device 1100 can be operated in resonance to take advantage of the large displacement and high speed operation. The actuation can be single-sided driven with one electromagnet 1150, or double-sided push-pull driven with an additional actuation mechanism implemented via a second electromagnet 1152.

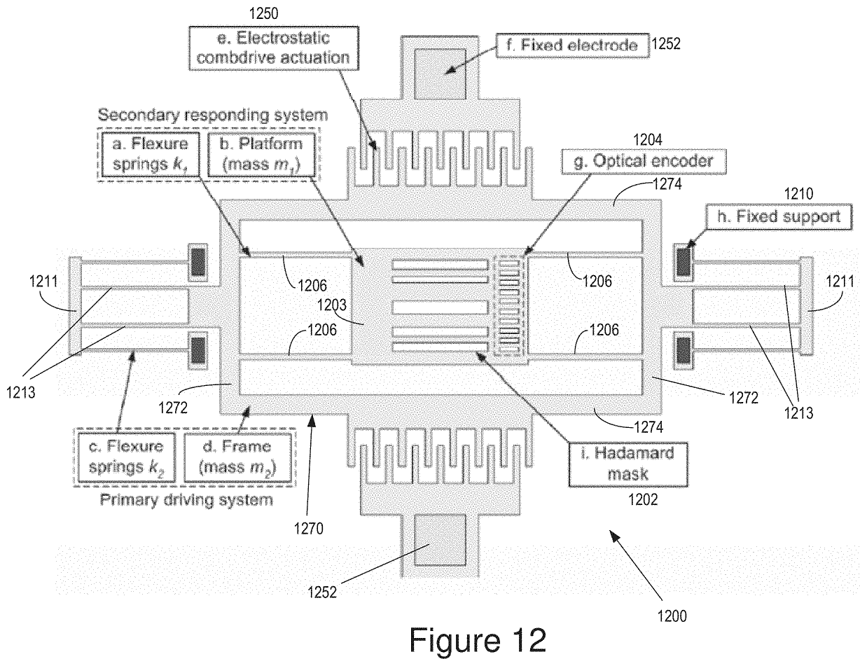

FIG. 12 shows a possible implementation of the amplitude amplification scheme depicted in FIG. 8. In FIG. 12, the light encoding device 1200 is electrostatically driven.

Light encoding device 1200 comprises a Hadamard mask 1202 that is carried on a platform 1203 that also carries an optical encoder element 1204 for position feedback.

The platform 1203 is attached at each side to a surrounding rectangular frame 1270 comprising a pair of side bars 1272 and a second pair of bars 1274 that is orthogonal to the side bars 1272. In particular, each side is attached to one of the side bars by thin elastic beam elements 1206 which collectively form a first flexure spring having spring constant k₁. The surrounding frame 1270 is in turn connected to respective bars 1211 of fixed supports 1210 by elastic beams 1213. The elastic beams 1213 form a second flexure spring having spring constant k₂. The frame 1270 is driven by an electrostatic comb drive actuator 1250 that receives a driving voltage via an electrode 1252.

The second flexure spring 1213 and the frame 1270 constitute the primary driving system, and the platform 1203 and the flexure spring 1206 constitute the secondary responding system. Large displacement of the secondary response system can be achieved through proper mode amplification.

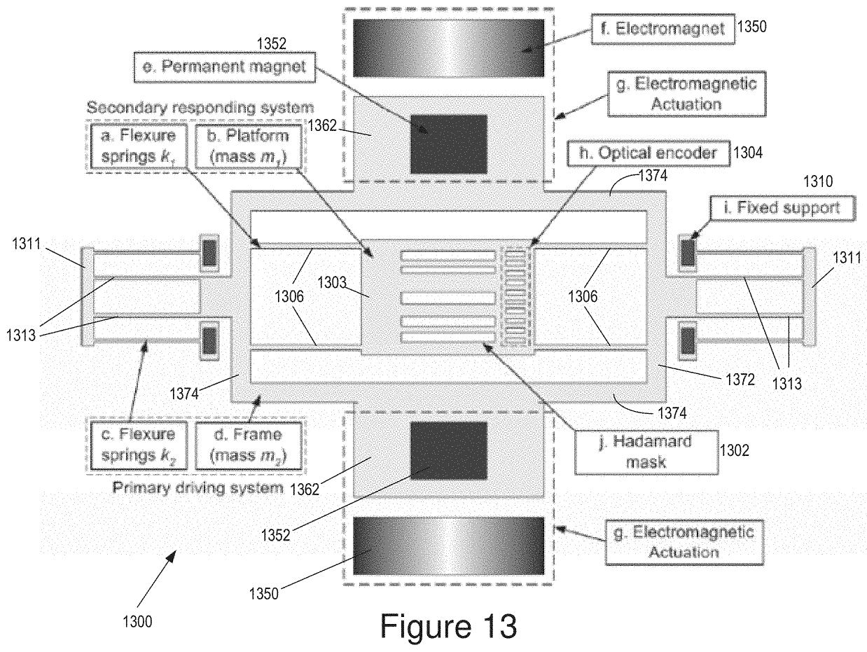

FIG. 13 illustrates an embodiment that is similar to the light encoding device 1200 of FIG. 12, but that is electromagnetically driven.

Light encoding device 1300 comprises a Hadamard mask 1302 that is carried on a platform 1303 that also carries an optical encoder element 1304 for position feedback. The platform 1303 is attached at each side to a surrounding frame 1370 comprising a pair of side bars 1372 and a second pair of bars 1374 that is orthogonal to the side bars 1372. In particular, each side is attached to one of the side bars 1372 by thin elastic beam elements 1306 which collectively form a first flexure spring having spring constant k₁. The surrounding frame 1370 is in turn connected to respective bars 1311 of fixed supports 1310 by elastic beams 1313. The elastic beams 1313 form a second flexure spring having spring constant k₂. The frame 1370 has a pair of panels 1362 extending from each side thereof, in particular from the bars 1374, each panel 1362 carrying a permanent magnet 1352 such that the device 1300 can be driven by electromagnets 1350 (either from a single side or from both sides).

The second flexure spring 1313 and the frame 1370 constitute the primary driving system, and the platform 1303 and the flexure spring 1306 constitute the secondary responding system. Large displacement of the secondary response system can be achieved through proper mode amplification.

### Two-Dimensional (2D) Hadamard Encoding

It is known that 2D Hadamard encoding can generally be implemented in two ways. A first implementation uses two orthogonally-scanning 1D Hadamard masks, and a second implementation uses a single encoding mask moving in two orthogonal directions.

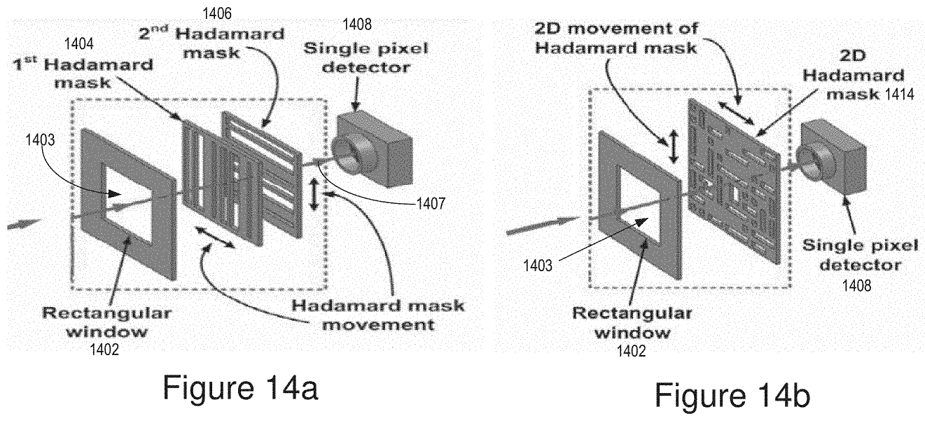

Generating 2D Hadamard encoding patterns on the image plane using two orthogonally-scanning 1D Hadamard masks, as shown in FIG. 14a, is relatively simple for implementation and control. A first 1D Hadamard mask 1404 and a second 1D Hadamard mask and a frame 1402 defining a viewing window 1403 can be placed in alignment with each other along a viewing axis 1407 of a single-pixel detector 1408. Although the frame 1402 is shown as being placed at the front of (i.e., closest to the object or light source being imaged) the arrangement in FIG. 14a, it will be appreciated that they may be placed in any sequence. In some embodiments, the masks 1404, 1406 can be combined to produce encoding by imaging one 1D Hadamard mask onto the other with additional lenses. The use of two 1D Hadamard masks also provides freedom in selecting any ratio of pixel dimensions of the image as the encoding mechanisms along two orthogonal directions are effectively decoupled. However, since the light passes through two Hadamard masks and is thus encoded twice, it will be appreciated that the signal-to-noise ratio may be lower than if a single mask that provides a comparable set of Hadamard patterns is used.

Conceptually, the operation principle of the encoding method shown in FIG. 14a is an extended version from the single line imaging as follows. After the first Hadamard mask 1404 is set to the i^{th} configuration (i=1, 2, . . . , M) to encode the radiation passing though the rectangular window 1402, the second Hadamard mask 1406 is sequentially moved through N different positions to further encode the radiation to be recorded by the detector. The first Hadamard mask 1404 is then set to the next position, and the process is repeated until all M×N measurements are done. Mathematically, this can be expressed as:

$${m}_{ij} = {\sum }_{k = 1}^{M} {\sum }_{l = 1}^{N} {a}_{ik} I ( {x}_{k} , {x}_{l} ) {b}_{lj} \qquad ( 4 )$$

where mᵢⱼ is the ij^{th} measured intensity signal, I(xₖ,yᵢ) is the radiation intensity centered at a position (xₖ,yₗ) on the rectangular window 1402, aᵢₖ is the attenuation at x=xₖ on the window produced by the first Hadamard mask 1404 setting at the i^{th} configuration, bᵢⱼ is the attenuation at y=yₗ by the second Hadamard mask 1406 setting at the j^{th} configuration. The values of aᵢₖ and bᵢⱼ are either 1 or 0, corresponding to passing or blocking conditions of the Hadamard masking patterns, respectively. Equivalently, Eq. (4) may be rewritten in a single matrix equation:

M=AIB (5)

with the matrices M=[mᵢⱼ], A=[aᵢₖ], I=[Iₖₗ]=[I(xₖ,yₗ], and B=[bᵢⱼ]. Consequently, the 2D image I(xₖ,yₗ) can be reconstructed by:

I=A⁻¹MB⁻¹ (6)

The step motions of the Hadamard slit masks 1404, 1406 may also be replaced with continuous scanning motions to scan the image field.

On the other hand, 2D Hadamard encoding patterns can also be generated with a single encoding mask 1414 moving in two orthogonal directions as shown in FIG. 14b. One way to implement this encoding scheme is through folding a one-dimensional array to a two-dimensional array. In this case, the mathematical model directly follows the 1D line imaging described from Eq. (1) to (3). Generating 2D Hadamard encoding patterns with a single encoding mask 1414 has the advantage of high SNR as the light passes through the mask only once. It will be appreciated that with this method, there may be less freedom in selecting the ratio of image pixel dimensions as the encoding of the two orthogonal image directions is coupled.

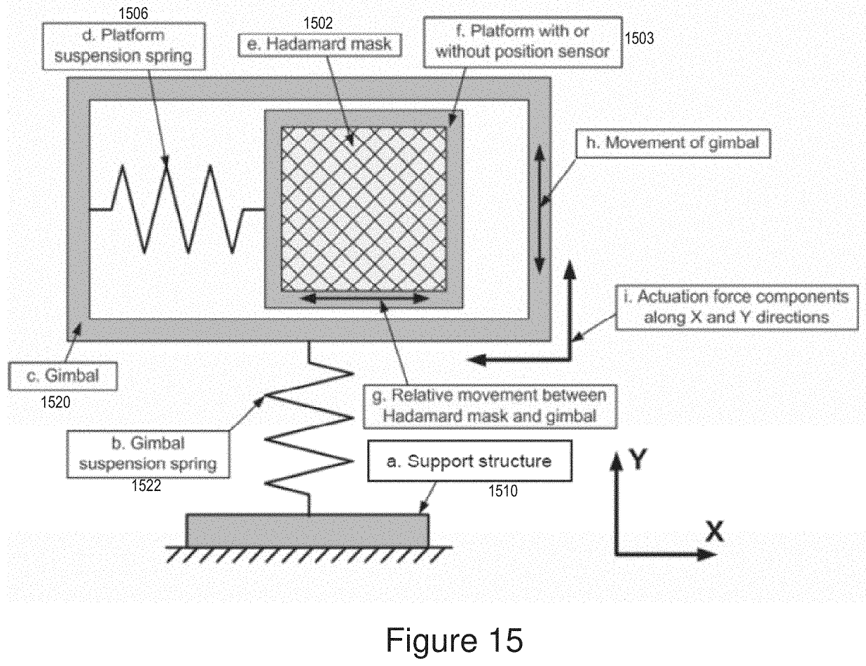

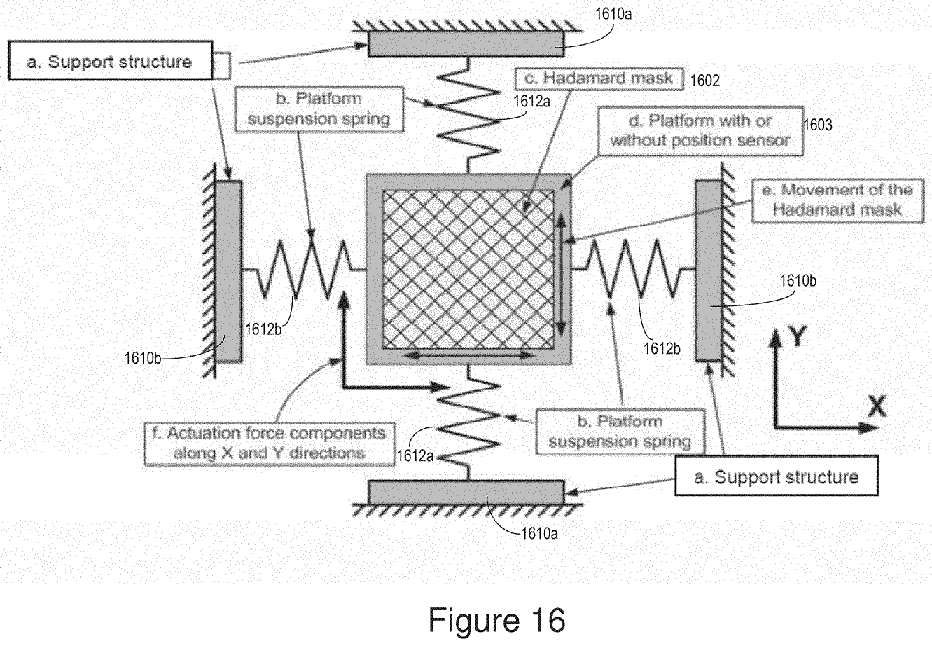

The driving mechanisms for the system in FIG. 14a can be implemented in accordance with any of the schematics shown from FIG. 5 to FIG. 9 using any actuation forces including electrostatic, electromagnetic, piezoelectric, and electrothermal. The driving mechanisms for FIG. 14b however are different and can be generally categorized into two types, namely a gimbal-like configuration and a gimbal-less configuration as illustrated schematically in FIGS. 15 and 16 respectively.

For the gimbal-like configuration shown in FIG. 15, a platform 1503 carrying a 2D Hadamard mask 1502 is connected to a gimbal structure 1520 through an oscillator such as a spring flexure 1506. The spring flexure 1506 supports a relative movement between the platform 1503 and the gimbal structure 1520. The gimbal structure 1520 is further connected to a support structure 1510 through a gimbal suspension spring 1522, which supports a relative motion between the gimbal structure 1520 and support 1510. The support structure 1510 can be fixed or moveable. Typically, the respective motions of the gimbal structure 1520 and platform 1503 are mutually perpendicular. When operated, the gimbal structure 1520 together with the spring 1506, platform 1503, and Hadamard mask 1502 scans along one direction (as indicated at h) relative to the support structure 1510, while the Hadamard mask 1502 itself scans along the orthogonal direction (as indicated at g) relative to the gimbal structure 1520, typically at a higher speed than the gimbal structure 1520 is scanned. The overall effect is the Hadamard mask 1502 scanning in two directions relative to the support structure 1510. In combination with a fixed window device (not shown in the figure), the moving Hadamard mask produces 2D Hadamard encoding patterns that can be used for 2D imaging applications. For quasi-static operation, actuation forces are applied to the gimbal structure 1520 and the platform 1503, driving along their respective directions. For resonant operation, actuation forces can be exerted on the platform 1503, gimbal structure 1520, support structure 1510, or any combination of these. For the direction h, as long as there is at least one force component the frequency of which matches the natural frequency of the structure along this direction, the gimbal structure 1520 together with platform 1503 oscillates along the direction h. Similarly as long as there is at least one force component the frequency of which matches the structure natural frequency along the direction g, the platform 1503 oscillates along this direction.

FIG. 16 shows a gimbal-less driving scheme for a 2D Hadamard mask 1502. As shown, the platform 1503 carrying the Hadamard mask 1502 is suspended to a support structure through at least one oscillator. For example, the support structure may comprise two pairs of support elements, with a first pair of support elements 1610a lying either side of the platform 1603 in a first direction Y, and a second pair of support elements 1610b lying either side of platform 1603 in a second direction X. Each support structure 1610a, 1610b is coupled to the platform 1503 via respective oscillators such as flexure springs 1612a, 1612b.

The springs 1612a, 1612b are designed to be flexible along the desired respective scan directions (i.e. X and Y) and rigid for other degrees of freedom. The support structure elements 1610a, 1610b can be fixed or movable. For quasi-static operation, actuation forces having force components along the X and Y directions are applied directly to the platform 1503. For resonant operation, the actuation forces can be exerted on the platform 1503, or the support structure elements 1610a, 1610b, or a combination of these. The platform 1503 can be driven to vibrate along the desired scan directions, as long as there is at least one force component along each direction the driving frequency of which matches the structural natural frequency along the respective direction.

### Imaging Systems

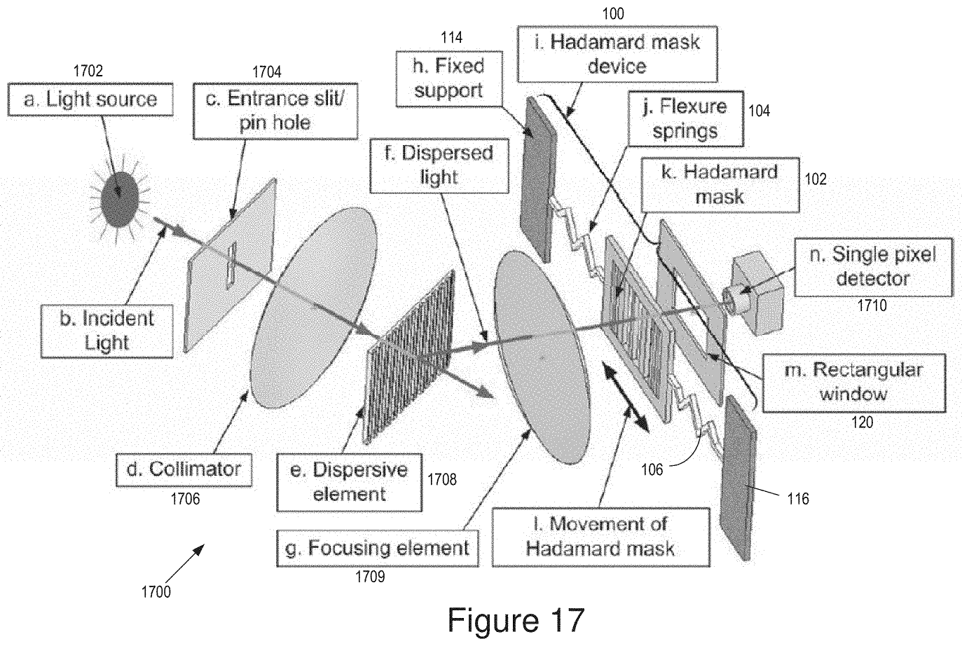

One application of a light encoding device according to certain embodiments, for example the light encoding device 100 of FIG. 1, is as part of an optical spectrometer, as depicted schematically in FIG. 17. Incident light from a light source 1702 is first passed through an entrance slit or pinhole 1704. The light is then collimated with a collimator 1706 before being split into its spectral components through a dispersive element 1708. The light encoding (Hadamard mask) device 100 oscillates to time-sequentially encode the optical spectral components passing through the window 120 and reaching a single-pixel detector 1710. The window 120 can be placed before or after the Hadamard mask device 100. An aggregate intensity of the encoded dispersed light is thus obtained at the detector 1710. Multiple readings are taken as the Hadamard mask 102 is moved throughout its travel range, resulting in different Hadamard encoding patterns through the window 120. The obtained aggregate intensities are then post-processed to reconstruct the spectral components of the dispersed light.

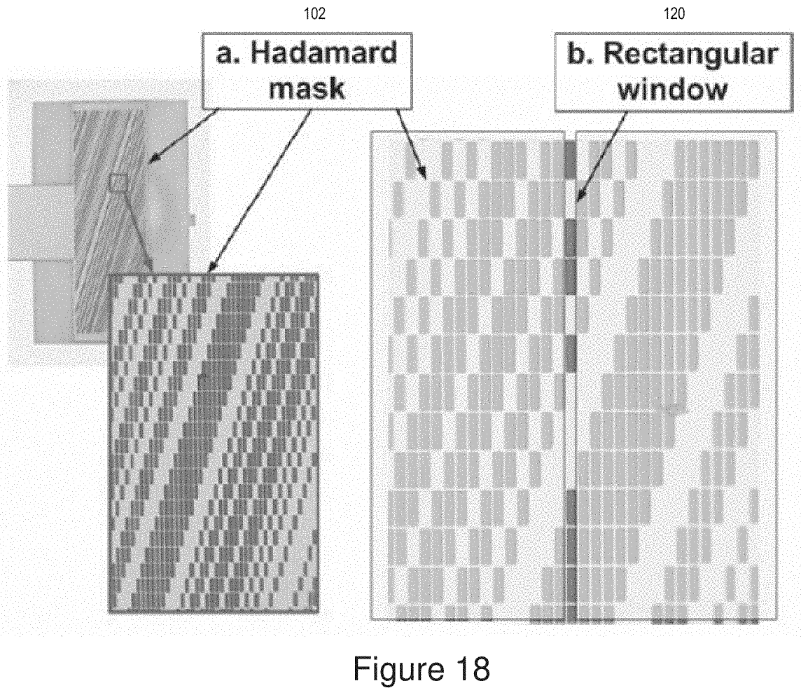

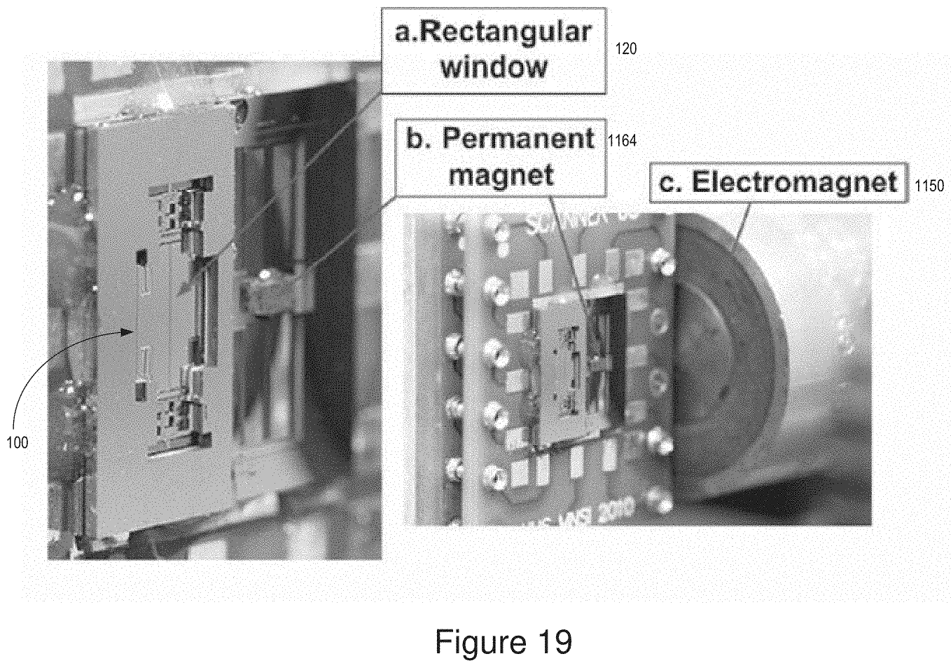

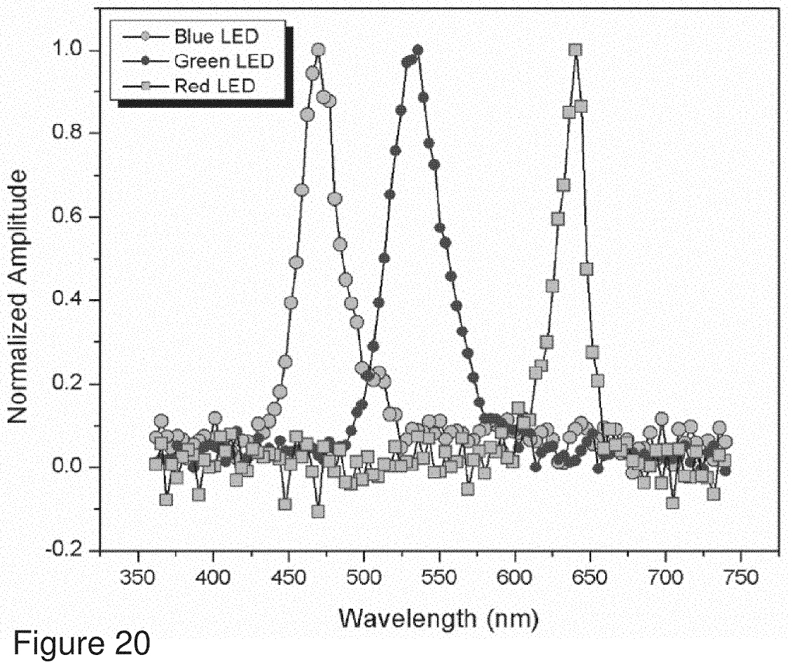

In one example, a spectrometer in accordance with the layout of FIG. 17 was implemented using microelectromechanical systems (MEMS) technology. A Hadamard mask 102 with a mounted rectangular window 120 is shown in FIG. 18. The Hadamard mask 102 and the resulting exposed Hadamard pattern through the window 120 are both illustrated. A photograph of the Hadamard mask device 100 with an assembled permanent magnet 1164 is shown in FIG. 19. An electromagnet 1150 is used to actuate the Hadamard device 100. The driving mechanism is designed according to that depicted in FIG. 11, with only one-sided electromagnetic actuation. Sample spectral results are shown in FIG. 20 for red, green and blue LEDs.

Another application of certain embodiments is miniature imagers with a single-pixel photodetector, which has the advantage to operate at any wavelength with low cost.

Two configurations are possible, one uses a single 2D Hadamard mask scanning in two directions (as shown in FIG. 14b) and the other uses a combination of two 1D Hadamard masks, with each scanning in a designated direction (as shown in FIG. 14a).

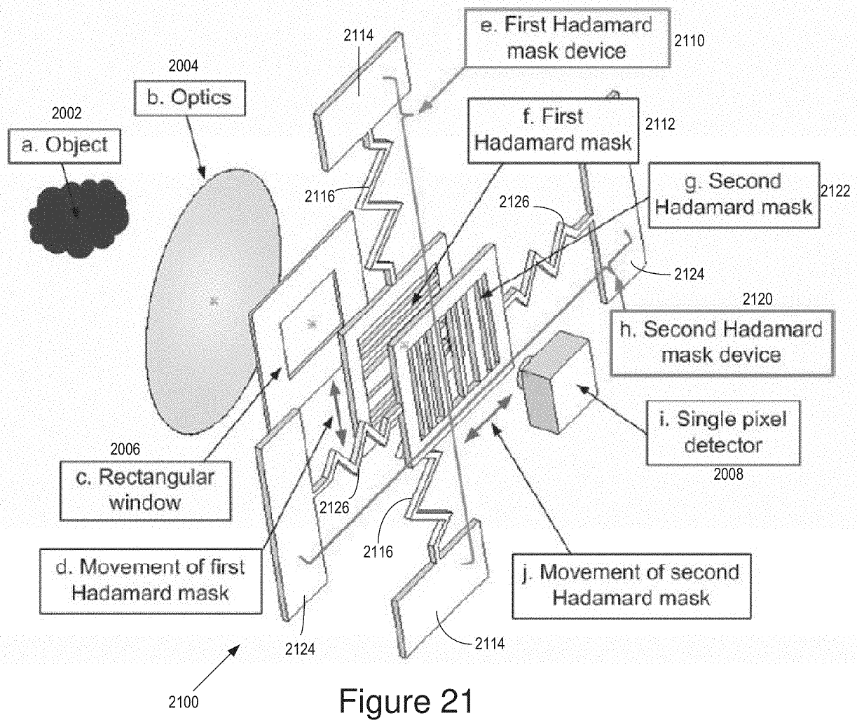

A schematic depiction of one possible implementation is shown in FIG. 21, in which a miniature imager uses two light encoding devices in the form of 1D Hadamard masks 1404, 1406. A single 1D Hadamard mask device encodes a single line of the image field. Two Hadamard mask devices arranged in sequence and orthogonal to each other can be used to encode a two-dimensional image field.

As shown in FIG. 21, two Hadamard mask devices 2110, 2120 are arranged orthogonal to each other and are configured to scann in orthogonal directions. Each Hadamard mask device 2110 is of similar construction to the light encoding device 100 of FIG. 1. The first Hadamard mask device 2110 comprises a first Hadamard mask 2112 that is coupled to a first pair of opposed support structures 2114 by respective first oscillators 2116. The second Hadamard mask device 2120 comprises a second Hadamard mask 2122 that is coupled to a second pair of opposed support structures 2124 by respective second oscillators 2126. The image field through the window 2006 is thus Hadamard encoded through the combined generated (e.g. micro-structured) patterns on the two devices. The window 2006 can be placed in front of the two Hadamard mask devices 2110, 2120, in between them, or after them (e.g., between the second mask device 2120 and the detector 2008). The two Hadamard mask devices 2110, 2120 can be placed in close proximity to each other, or imaging optics can be placed in between them imaging one onto another. The aggregate Hadamard encoded image field is then picked up by a single pixel detector 2008. The image is subsequently reconstructed.

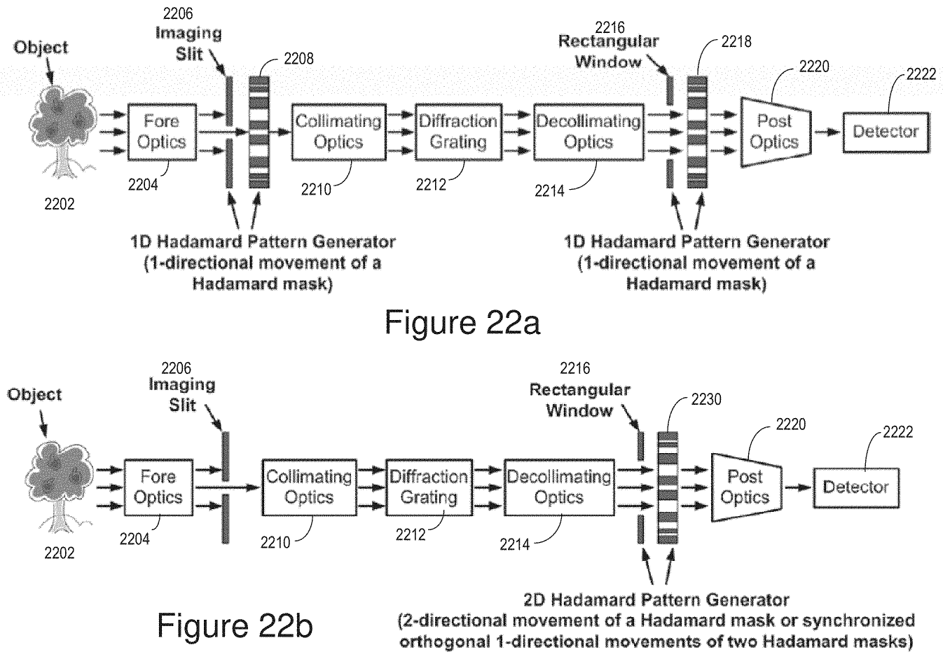

Another application of some embodiments is in spectral imagers. One dimension will be spatial and another dimension spectral. Examples of spectral imagers are shown in FIGS. 22a and 22b.

In a first configuration, shown in FIG. 22a, a spectral imager 2200 has an encoding-dispersion-encoding configuration. which makes use of two 1D Hadamard pattern generators 2208 and 2218, and which encodes spatial and spectral information separately. The light coming from the object 2202 is imaged on the imaging slit 2206 by fore optics 2204 and encoded spatially by the first 1D Hadamard pattern generator 2208. The encoded light is then collimated by collimating optics 2210 and dispersed by a diffraction grating 2212. The diffracted light is then focused by decollimating optics 2214 and passes through a window 2216 for encoding by the second Hadamard pattern generator 2218, which is placed at the focal plane of the decollimating optics 2214. Finally, the light passing through the second Hadamard pattern generator 2218 passes through post optics 2220 to be recorded by a single-pixel photo-detector 2222. The pattern generators 2208 and 2218 are moved (for example, by a mechanism in accordance with any of those shown in FIGS. 5 to 13) to sequentially expose the entire set of possible encoding patterns through the window 2216. After measuring light passing through all combinations between spatial and spectral encoding patterns, a hyper-spectral image can be obtained through the Hadamard transform. In a second configuration, shown in FIG. 22b, a spectral imager has a dispersion-encoding configuration. FIG. 22b is similar to FIG. 22a, but instead of using two 1D Hadamard pattern generators 2208 and 2218, there is only one 2D Hadamard pattern generator 2230, which is able to encode the light along two directions (spatial and spectral directions in a hyper-spectral image) at the same time. In this configuration, the incoming light passing through the imaging slit 2206 is collimated and dispersed. A 2D Hadamard pattern generator 2230 is placed at the focal plane of the decollimating optics 2214 and encodes the dispersed light two dimensionally. The pattern generator 2230 is moved (for example, in accordance with the mechanism shown in FIG. 15 or FIG. 16) to sequentially expose the entire set of possible encoding patterns through the window 2216. After light passing through all the encoding patterns is recorded, a Hadamard transform is applied to obtain the hyper-spectral image. Here, the 2D Hadamard pattern generator can be implemented either with a single 2D Hadamard mask moving in two directions or two orthogonally scanning 1D Hadamard masks (for example, as shown in FIG. 14a).

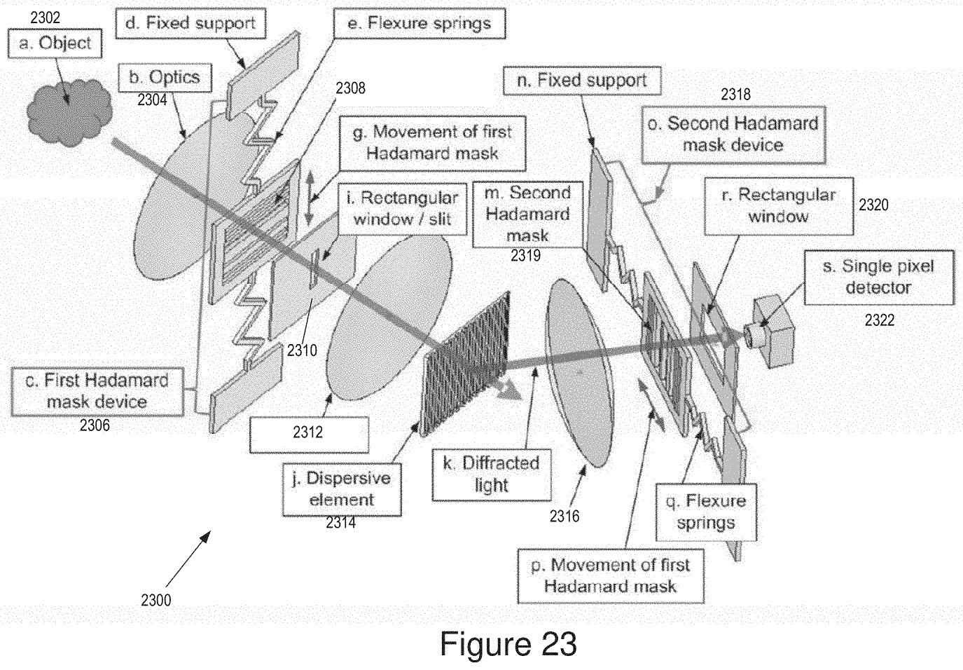

The two configurations shown in FIGS. 22a and 22b may be implemented in many ways. For example, as shown in FIG. 23, a line spectral imaging system 2300 may comprise optics 2304 that images a scene or an object 2302 onto a slit 2310. The imaging system 2300 is designed to capture the spectrum of each resolvable spatial element or pixel along this slit 2310 over an operational wavelength band. A first Hadamard mask device 2306 is placed immediately before or after the slit 2310 to selectively pass the light from the designated pixels to enter the imaging system. The Hadamard mask device 2306 has a Hadamard mask 2308 that encodes the incoming radiation corresponding to a cyclic S-matrix of certain size. The Hadamard mask 2308 is arranged relative to the slit 2310 according to the configurations shown in FIG. 2 or FIG. 3 (for example) and is moved one dimensionally along or perpendicularly to the direction of the slit 2310 to generate all possible encoding patterns inside the slit frame. At any one time, only the selected pixels are viewable through the slit window opening 2310 by the imager. After the radiation passing through one encoding pattern has been measured, the encoding pattern is replaced with another by moving the Hadamard mask 2308. The process is repeated until enough measurements have been made to reconstruct the information at the slit 2310. The slit 2310 can be placed in front of the Hadamard mask device 2306 or after it.

Through the slit 2310 and the first Hadamard mask 2308, all the radiation that is allowed to pass is collected and collimated by a collimator 2312 and goes through a dispersive element 2314. The radiation is then dispersed into its spectral components to be modulated by a second Hadamard mask 2319 of a second Hadamard mask device 2318. The dispersed light is focused through focusing element 2316 to an image plane, where a rectangular window 2320 is placed. The second Hadamard mask device 2318 is placed immediately before or after the window 2320. The rectangular window 2320 together with the second Hadamard mask 2319 further encodes the radiation that can finally reach the single-pixel photodetector 2322. The second Hadamard mask 2319 is actuated in a direction to encode the spectral information.

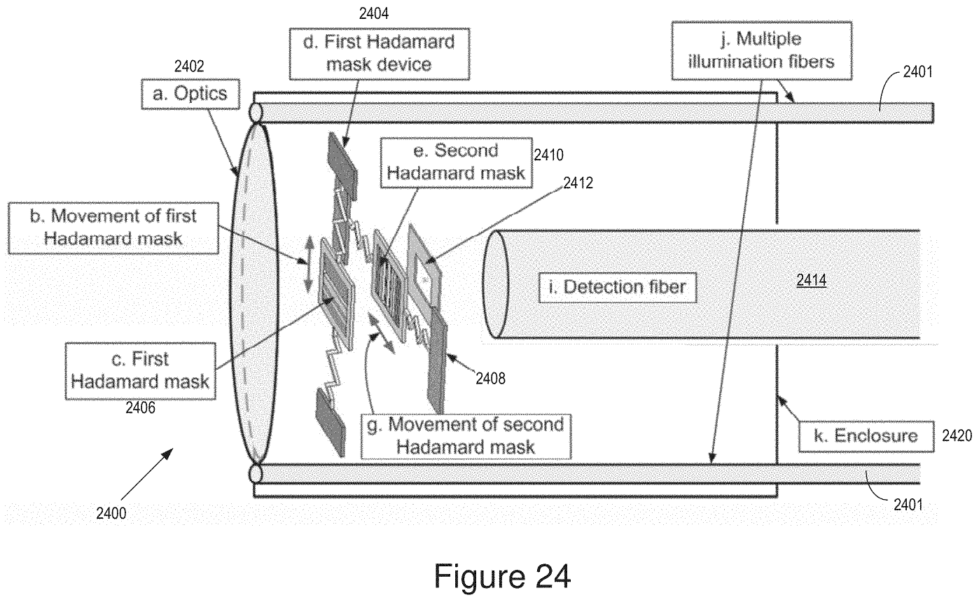

Some embodiments provide a miniature endoscope imager, for example as shown in FIG. 24. The endoscope imager 2400 in FIG. 24 uses two 1D Hadamard masks 2406 and 2410, though it will be appreciated that these may be replaced by a single 2D Hadamard mask, as explained in relation to other embodiments. The single-pixel detector of other embodiments is replaced here by a single optical fiber or light guide 2414 to collect the Hadamard encoded radiation. The endoscope enclosure 2420 contains single or multiple illumination fibers/light guides 2401. Radiation reflected from the surrounding illuminated objects enters through the optics 2402 and is Hadamard encoded two-dimensionally through two orthogonal Hadamard mask devices 2404, 2408 and a window 2412. The encoded radiation is collected by the detection fiber/light guide 2414 and is optically picked up by a detector at the other end, outside of the endoscope. The window 2412 can be placed in front of the two Hadamard mask devices 2404, 2408, in between them, or after them. Alternatively, relay optics can be inserted between the two Hadamard mask devices 2404, 2408, to image one Hadamard encoding pattern onto another.

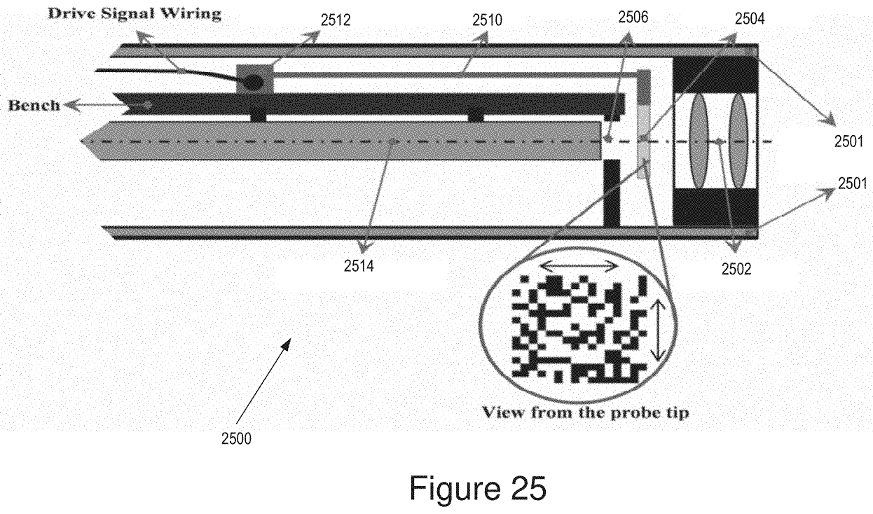

FIG. 25 illustrates a further example of a miniature Hadamard-transform-based endoscope 2500 that uses a single 2D mask 2504 that is scanned in two directions. As shown in the figure, a lens system 2502 is provided at the front of the endoscope probe 2500 to provide a large FOV. The lens system 2502 images the object of interest onto the rectangular window 2506. To encode the image, a 2D Hadamard mask 2504 is placed immediately before or after the rectangular window 2506. The mask 2504 is suspended by flexures 2510 and controlled by a micro actuator 2512 to scan two directionally. Through the movement of the mask 2504 on the image plane, the image is encoded according to a desired cyclic S-matrix. The optical signal through the window 2506 and mask 2504 is then coupled to a delivering fiber 2514 and transmitted to the outside for further processing to reconstruct the image. In the endoscopic probe 2500 described here, a fiber ring comprising illumination fibers 2501 can be integrated around the probe tube to provide illumination of the object.

Imaging Systems with Cascaded Hadamard Masks

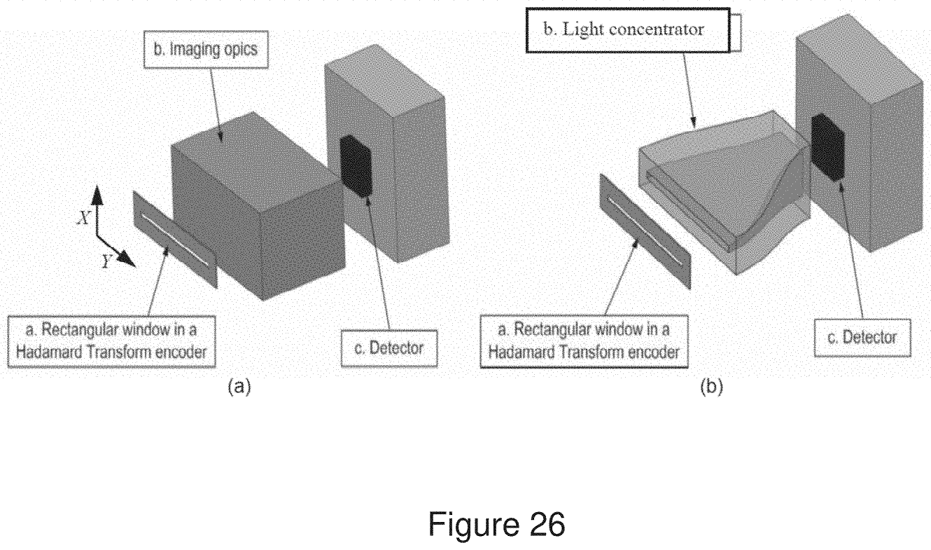

For embodiments of the Hadamard-transform-based system disclosed here, a relatively large rectangular window size is beneficial for a good sensor resolution and throughput. However, the size of the single-pixel photodetector is usually small. Small detector size typically provides low noise and fast response speed. Hence, in order for the imaging system to achieve high performance, an optical system may be placed between the window and the photodetector, to shrink the effective rectangular window size to match the detector size. As shown in FIG. 26a, this function can be implemented through imaging optics with an optical magnification less than one. In cases where different magnification ratios along the X and Y directions are required to match the window size and the photodetector size, cylindrical lenses and/or prisms can be included in the optics.

Another method to achieve size matching is shown in FIG. 26b, and this method is based on non-imaging optics. To match the sizes of the rectangular window and the photodetector, a light concentrator (a shaped hollow reflective device) can be used, and can achieve low-cost and compact packaging and integration. Many different types of light concentrators can be used, for example from structures as simple as light cones to as complex as compound parabolic concentrators (CPC).

In imaging systems that use only one single-pixel photodetector, the resolution of the image obtained may be limited by the strokes of the Hadamard mask. The reason is as follows. For a fixed pixel size (usually pixel size is determined by the SNR and system throughput considerations and cannot be too small), a higher resolution requires a larger rectangular window size. This translates into larger stokes required for the Hadamard masks to step through the window to generate a complete set of encoding patterns.

Accordingly, some embodiments remove this limitation to achieve high imaging resolution with relatively small Hadamard mask movement. Embodiments may make use of cascading multiple windows and Hadamard masks, and multiple light concentrators and photodetectors. This results in a compact imaging system having an increased resolution by N-fold with only a minimal increase in package size.

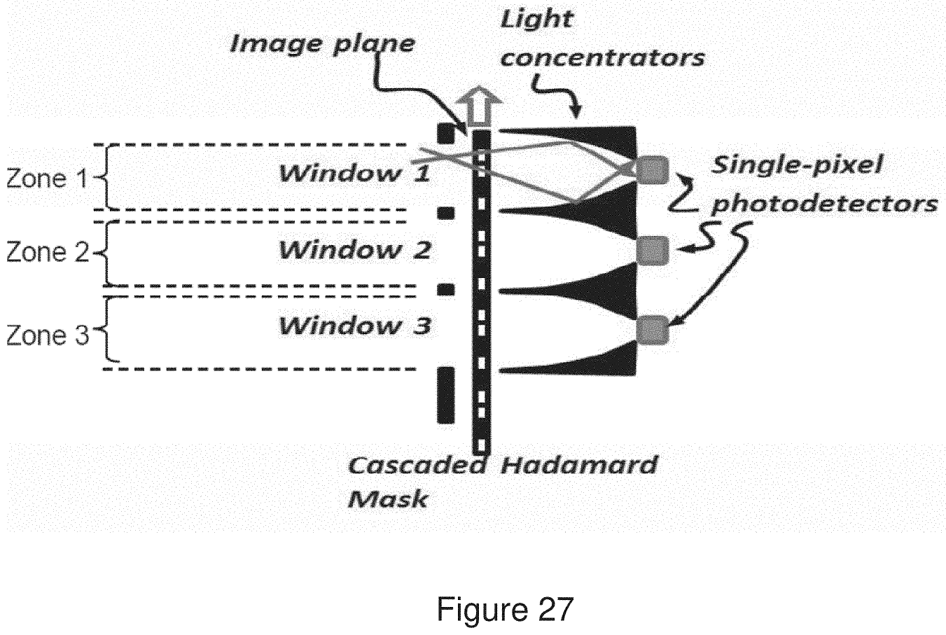

A schematic diagram of an example system is shown in FIG. 27. The image plane is divided into N detection zones (N=3 in FIG. 27). Each detection zone is associated with a window, a Hadamard encoding mask, a light concentrator, and a single-pixel photodetector. The Hadamard encoding masks can be designed and cascaded on a common platform driven by a common MEMS actuator. Due to the cyclic nature of the encoding patterns, such a design can be extremely compact and the detection zones can be placed one immediately after another with negligible gaps.

Some examples of imaging systems that achieve high-resolution imaging using cascading Hadamard masks will now be described.

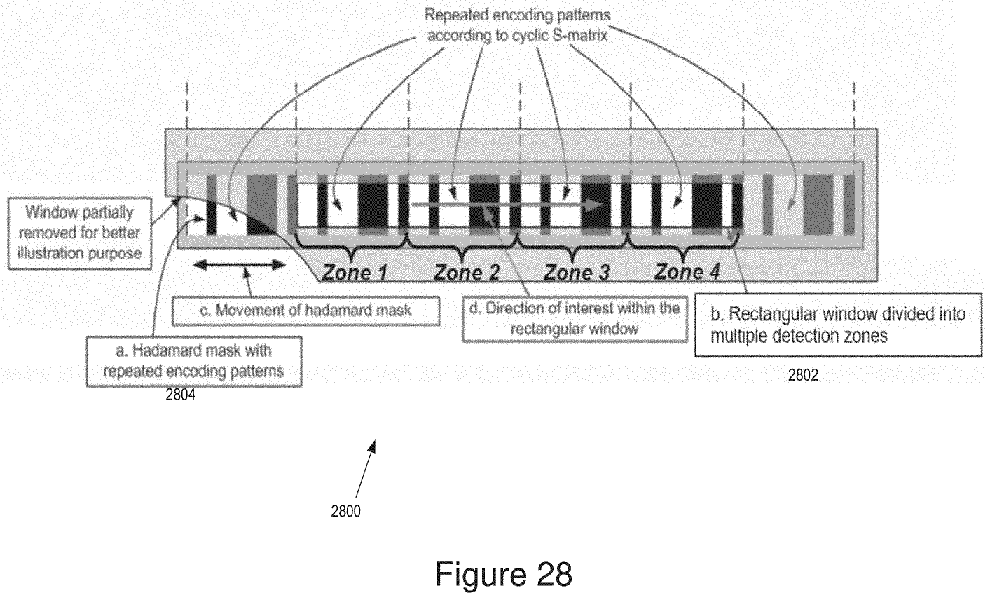

FIG. 28 shows cascading of Hadamard masks for 1D imaging using the first configuration shown in FIG. 2. As shown in the figure, a rectangular window 2802 is divided into a set of N detection zones (N=4 in the figure), each being associated with a window, Hadamard encoding mask, light concentrator (not shown), and a single-pixel photodetector (not shown). Accordingly, each window exposes a different part of the encoding patterns of the Hadamard mask 2804, such that the Hadamard mask 2804 effectively becomes a series of masks, one for each detection zone.

Although the windows for the detection zones shown in FIG. 28 are connected one after another seamlessly with zero gaps, in some cases they can be separated by a small gap to facilitate alignment and assembly. Due to the cyclic nature of the S-matrices, the Hadamard mask patterns are repetitive as shown. Hence, they can be compactly integrated into a common moveable platform and designed in a way such that when the platform displaces a step, the encoding pattern in each detection zone changes to the next pattern. As a result, the required platform stroke to image the intensity distribution within the whole rectangular window 2802 is now equal to the length of the detection zone, instead of the length of the entire rectangular window 2802. In other words, the required stroke of the platform is reduced by a factor of N by virtue of the cascading N detection zones.

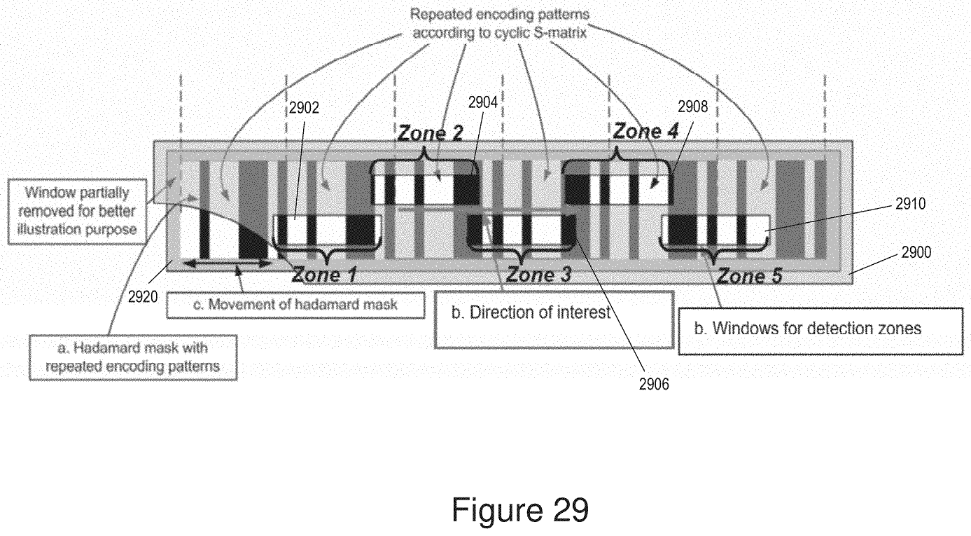

FIG. 29 illustrates a variant in which the detection zones can be overlapped along the direction of interest. This embodiment is of particular interest to line imaging applications for surveillance. Since the relative motion of objects to the imaging system is perpendicular to the direction of interest, no visual information is lost due to the overlapping detection zones.

In FIG. 29, a frame 2900 comprises a plurality of windows 2902, 2904, 2906, 2908 and 2910, each of which exposes a different part of the repeated encoding patterns of the Hadamard mask 2920, and which corresponds to a different detection zone. For example, the windows may be provided in a staggered arrangement which comprises a first row of windows 2902, 2906 and 2910 which are separated from each other in the direction of interest, and a second row of windows 2904 and 2908 which are also separated from each other in the direction of interest, and from the first row of windows in a direction orthogonal to the direction of interest. The windows of the first row may partially overlap with those of the second row along the direction of interest. For example, the right hand edge of window 2902 of detection zone 1 overlaps with the left hand edge of window 2904 of detection zone 2. As shown, different views of the repeated encoding patterns of the 1D Hadamard mask 2920 are visible through different windows, such that the encoding is different for different detection zones 1-5.

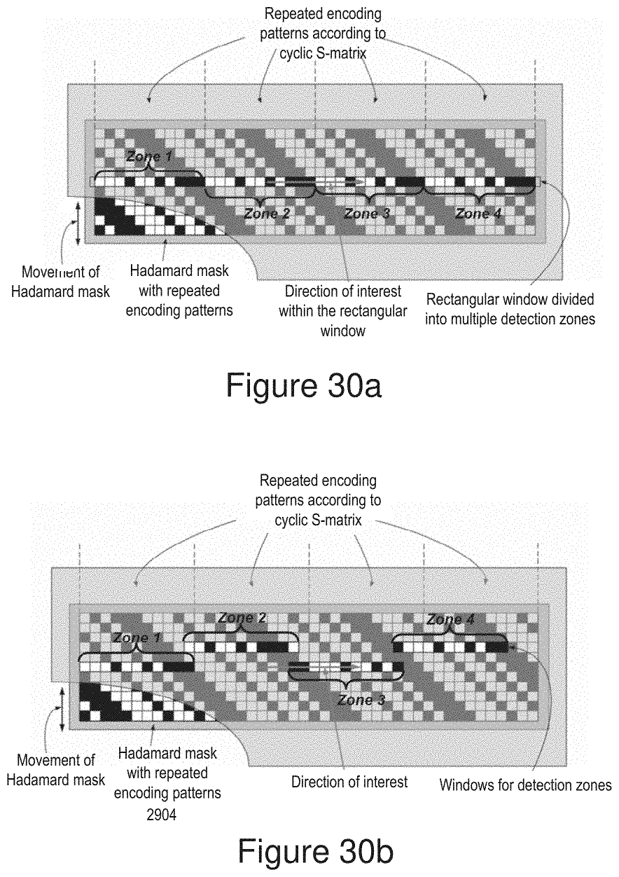

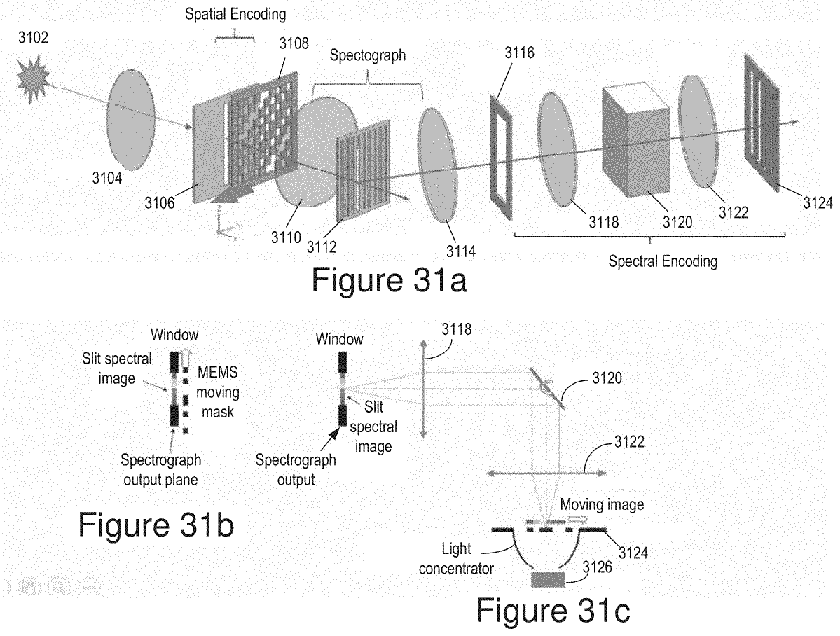

Other examples of cascading Hadamard masks for achieving high image resolution are illustrated in FIGS. 30a and 30b. In FIG. 30a, which is an adapted version of FIG. 3, a single rectangular window is divided into a series of non-overlapping windows, each corresponding to a detection zone, similarly to FIG. 28. In FIG. 30b, a plurality of windows are provided in a staggered arrangement, similarly to FIG. 29. Each window corresponds to a different detection zone, and different rows of the staggered arrangement of windows expose different rows of the pattern for the Hadamard mask.

### Spectral Imaging Systems

Turning now to FIG. 31a, one possible implementation of a spectral/hyperspectral imaging system (as shown schematically in FIG. 22a) will be described. Refractive optics is used for illustration, although it will be appreciated that an imaging system can be designed based on reflective optics (i.e. mirrors), which will be discussed in detail below.

As shown in FIG. 31a, an object 3102 is imaged by fore-optics 3104 onto a slit 3106, which limits the field of view of the imager 3100 to a line for push broom scan operation. A first Hadamard encoder 3108 is placed immediately after the slit 3106 to encode the slit 3106 spatially. A spectrograph comprising a collimator 3110, a grating 3112, and a focusing lens/mirror 3114 disperses the light and generates a spectral image of the slit 3106 at the fixed window 3116, where unwanted spectral bands are removed by the window 3116. Then in the next stage, the spectral encoding is implemented with a scanning system 3120 that moves the spectral image across a fixed Hadamard encoding mask 3124, where the image is encoded for a second time spectrally. After the light is encoded both spatially and spectrally, it is received by a single-pixel photodetector 3126 (FIG. 31c).

The embodiment of FIG. 31a has a couple of advantages. Referring to the embodiment shown in FIG. 23, the rectangular window 2320 is placed in the output plane of the hyperspectral imager 2300, and immediately before or after the window 2320 is the MEMS driven Hadamard moving mask 2319. The mask 2319 contains transparent and opaque pixels/cells and is scanned through the window 2320 generating a complete set of encoding patterns. However, although the speed of the MEMS encoders is sufficient, their vibration amplitudes are limited, which leads to a limitation in the number of spectral bands to be recorded. In the embodiment in FIG. 31a, whose second Hadamard encoding is further highlighted in FIG. 31c, a rectangular window is placed in the focal plane of the spectrograph output, which limits the spectral bands that can be transmitted through. After the window 3116, a collimating lens/mirror 3118 is used to collimate the light beams to a scanning mirror 3120. Reflected from the mirror, the light beams are focused again to a fixed Hadamard encoder 3124, which is secured and not movable. As shown in FIG. 31c, when the mirror 3120 rotates, the slit hyperspectral image scans across the fixed Hadamard encoder 3124 thus generating spectrally-encoded signals at each position. It is noted that since a rectangular window 3116 is used in blocking all unwanted wavelengths outside the operation band, this encoding mechanism is essentially the same as the encoding mechanism of FIG. 23. However, with this design, we can use resonant scanning mirrors that can be operated at both high speed and large rotation angles, thus achieving high imaging frame rate and, at the same time, high spectral resolution.

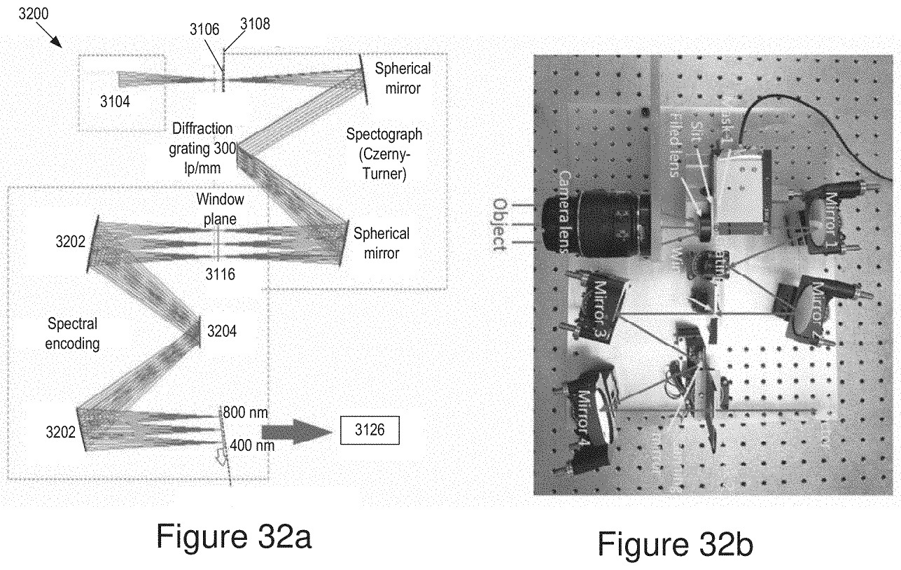

A prototype system was built to demonstrate the principle of the embodiment shown in FIG. 31a. A ray-tracing diagram of the developed system is shown in FIG. 32a, and a photo of the system is shown in FIG. 32b. As shown in FIG. 32a, the fore-optics 3104 images the scene to the slit 3106, where a movable encoding mask 3108 driven by a motorized stage is located immediately after it to encode the light spatially along the slit 3106. A Czerny-Turner spectrograph is then used to disperse and image the spatially-encoded slit to the fixed window 3116 plane generating a dispersed spectral image of the slit 3106. The fixed window 3116 blocks out the unwanted spectral bands and passes the spectral bands of interest. What follows is a spectral encoding mechanism comprising two spherical mirrors 3202 and a scanning mirror 3204, which further images the band-limited dispersed slit image onto the fixed spectral encoding mask 3124 (or the second Hadamard encoding mask). When the mirror 3204 scans, the dispersed slit image moves with respect to the fixed spectral encoding mask 3124, thus encoding the light in the spectral dimension. After that, the spatially and spectrally encoded light is collected by a single-pixel photodetector 3126. A spectral/hyperspectral image of the slit can then be reconstructed using the Hadamard transform as discussed before.

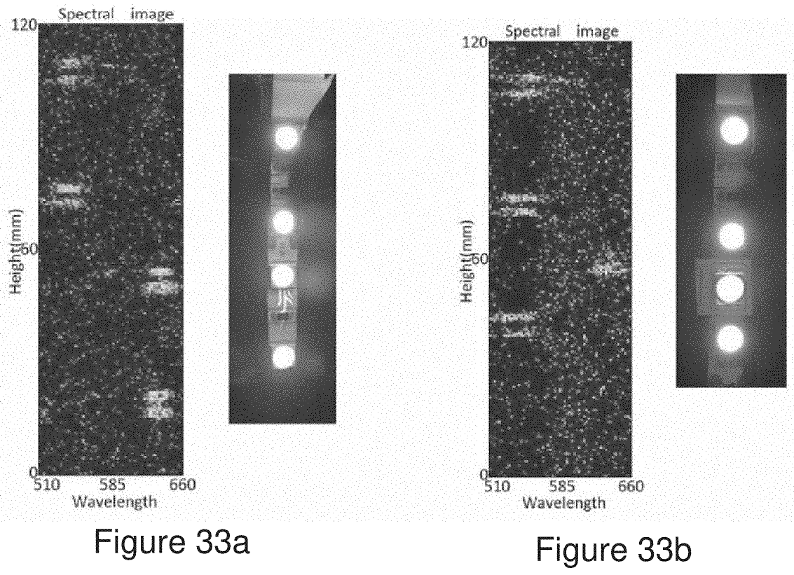

FIGS. 33a and 33b show experimental results of the hyperspectral imaging system 3300. Both the spectral images and the targets containing LED lights are provided. As shown in FIG. 33a, four LEDs are used with two green LEDs located in the upper region and two red LEDs located at the lower region. Clearly, the spectral image on the left side correctly records the heights of the LEDs (referring to the vertical axis of the image) as well as their spectra (referring to the horizontal axis for the emission wavelength). Furthermore, the spectral image also captures the internal structures of the LEDs which cannot be seen in the photo of the LEDs on the right side. Similarly, FIG. 33b also demonstrates that the captured spectral image is correct and accurate.

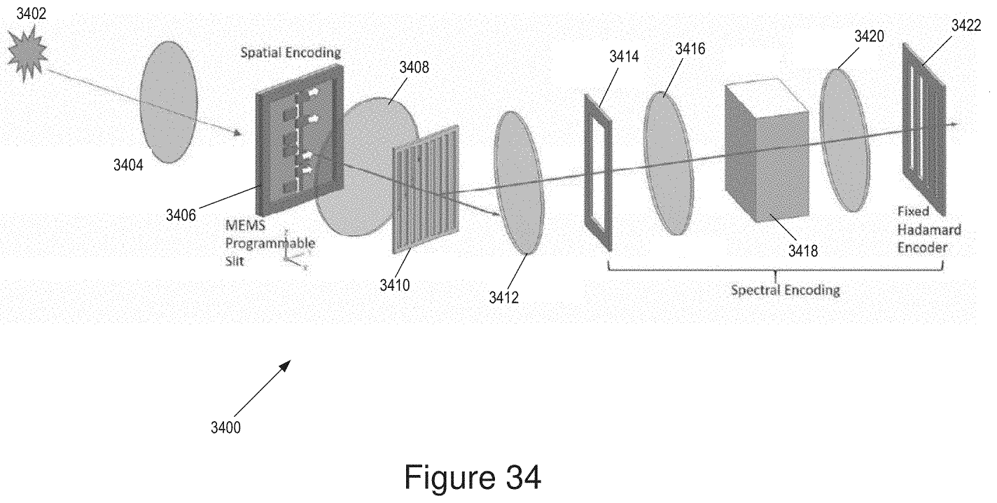

Another embodiment of a spectral/hyperspectral imaging system 3400, that uses a MEMS programmable slit for spatial encoding, is shown in FIG. 34. Instead of a motorized stage as in the embodiment of FIG. 32a, a dynamic mask in the form of a MEMS programmable slit 3406 is provided, resulting in a more compact system construction, and more importantly, a higher speed operation. As shown in FIG. 34, the MEMS programmable slit 3406 comprises an array of micro shutters 3407, each of which can close or open a pixel along the slit. Each micro shutter 3407 can be individually controlled to open and close thus producing the required spatial Hadamard encoding pattern. The resonant frequency of the micro shutters 3407 can be designed to be at several tens of kHz, which means that the shutters 3407 can be opened and closed within a duration of micro seconds.

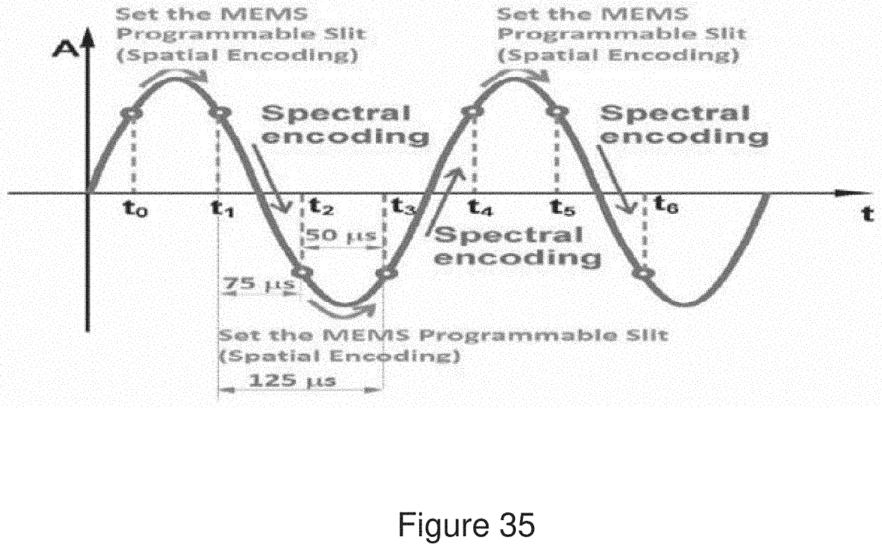

In addition, with the use of a high-speed MEMS programmable slit 3406, the synchronization of the spatial and spectral encoders in a spectral/hyperspectral system 3400 can also be greatly simplified. FIG. 35 further shows schematically the synchronization scheme. As shown, the sinusoidal oscillation of the resonant scanner as a function of time for spectral encoding is highlighted. During the time period from t₁ to t₂, the scanner scans in one-direction. Its angular velocity is relatively linear and the spectral encoding is carried out in this period. From time t₂ to t₃, the scanner is altering its direction and the angular velocity is highly nonlinear, such period cannot be used for spectral encoding. However, re-positioning of the micro shutter elements 3407 in the slit 3406 and setting the next slit spatial encoding pattern can be nicely carried out in this period. Due to the high operation speed of the micro shutters 3407, setting up the next slit spatial encoding pattern can be done at the microsecond level. In this way, the spatial and spectral encoding schemes are implemented in a staggered way in the time domain.

In the above embodiments of the spectral/hyperspectral imaging system 3400, the spatial encoding is done at the slit 3406 and spectral encoding is carried out using a scanning system with a fixed Hadamard mask 3422. The two encoding schemes are cascaded, i.e. spatial encoding first followed by spectral encoding in two separate systems. In some embodiments, the two spatial and spectral systems can be united as one single system instead of two cascaded systems, thereby reducing the footprint of the spectral imaging system and also reducing or eliminating the need for precision alignment.

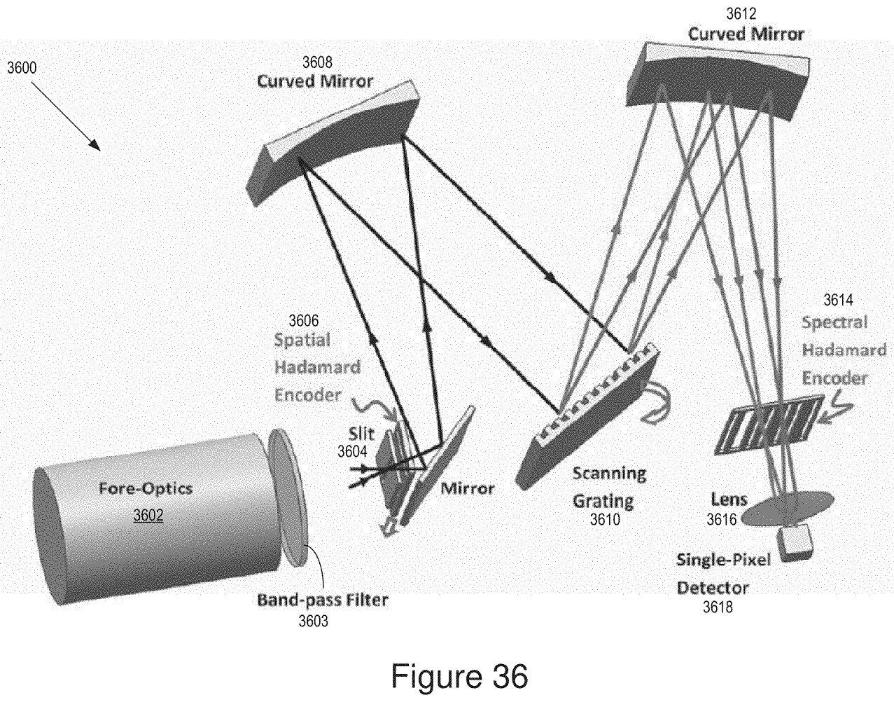

For example, FIG. 36 shows an embodiment of a spectral/hyperspectral system 3600 in which spatial and spectral encoding schemes are integrated in one system. The system 3600 comprises an imaging fore-optics 3602 that projects a scene or an object of interest onto a window structure comprising an aperture (slit) 3604, where the light is encoded spatially with a moving Hadamard encoding mask 3606 located immediately behind the slit 3604. Light passing through the slit 3604 is collimated by a curved mirror 3608 and dispersed by a diffraction grating 3610, and then focused by a focusing mirror 3612 to produce dispersed slit images (a hyperspectral image). Right at the hyperspectral image plane, a second Hadamard encoding mask 3614 is located to encode the spectral dimension. In this embodiment, spectral encoding is implemented with a rotationally oscillatory diffraction grating 3610 in combination with a fixed Hadamard mask pattern 3614 and a broadband optical bandpass filter 3603. The functionality of the broadband optical bandpass filter 3603 is similar to the fixed window in FIG. 31a, i.e. to block the unwanted wavelengths and allow the spectral bands of interest to pass. Such a design may lead to a better system performance. Light passing through the second Hadamard encoding mask 3614 is then collected and focused to a single-pixel photodetector 3618.

The encoding mechanism is briefly described as follows. When the first spatial Hadamard encoding mask 3606 moves to its ith position (i=1, 2, . . . , M), the slit 3604 is firstly encoded spatially along its length direction. Subsequently, the diffraction grating 3610 rotates and changes the light incident angle, thus moving the dispersed slit images across the second fixed Hadamard encoder 3614, which passes the slit images at the selected wavelengths to encode the spectral dimension. When all N different spectral encoding patterns are completed, the first Hadamard mask 3606 then moves to its next (i+1)th position and the process is repeated until all the M×N measurements are done. A 2D hyperspectral slit image is then reconstructed through a Hadamard transformation. It should be noted that one can also use a fixed diffraction grating in combination with a scanning mirror to achieve the same functionality of spectral encoding.

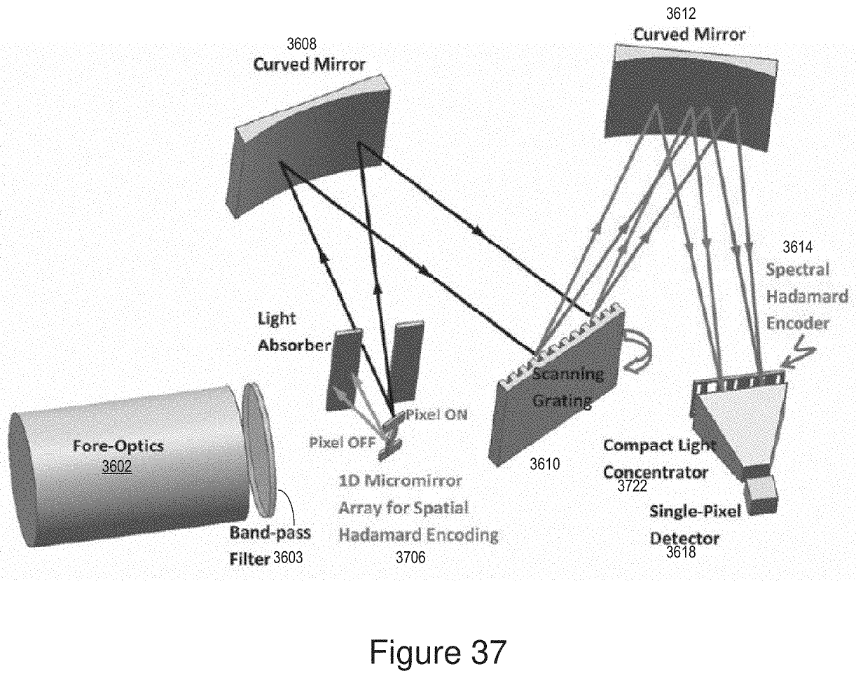

In yet another embodiment similar to that shown in FIG. 36, the spatial encoding is implemented via a micromirror array 3706. The system setup is schematically shown in FIG. 37. While the optical system remains mostly unchanged, the slit 3604 however is replaced with a linear micromirror array 3706, with each mirror element representing a pixel. When the micromirror element is in its original state, it reflects light into the imaging spectrometer and the pixel is in an “ON” state. On the other hand, when the micromirror is actuated, its reflected light is blocked and the pixel is in an “OFF” state. Spatial encoding may therefore be implemented by selectively turning pixels on or off in accordance with the desired encoding patterns. A good characteristic of such tiny micromirrors is their very high resonant frequency in the range of hundreds of kHz and their ability to switch within tens of microseconds. With the design of FIG. 37, the spectral/hyperspectral imager 3700 no longer has low mechanical resonance devices, and is hence more robust against external vibrations. This is advantageous for unmanned aerial vehicle (UAV) surveillance applications. In the embodiment shown in FIG. 37, a compact light concentrator 3722 is used to match the output size of the spectral encoder 3614 with the photosensitive area size on the single-pixel detector 3618. The advantages of using a non-imaging concentrator 3722 over imaging optics include more compact size.

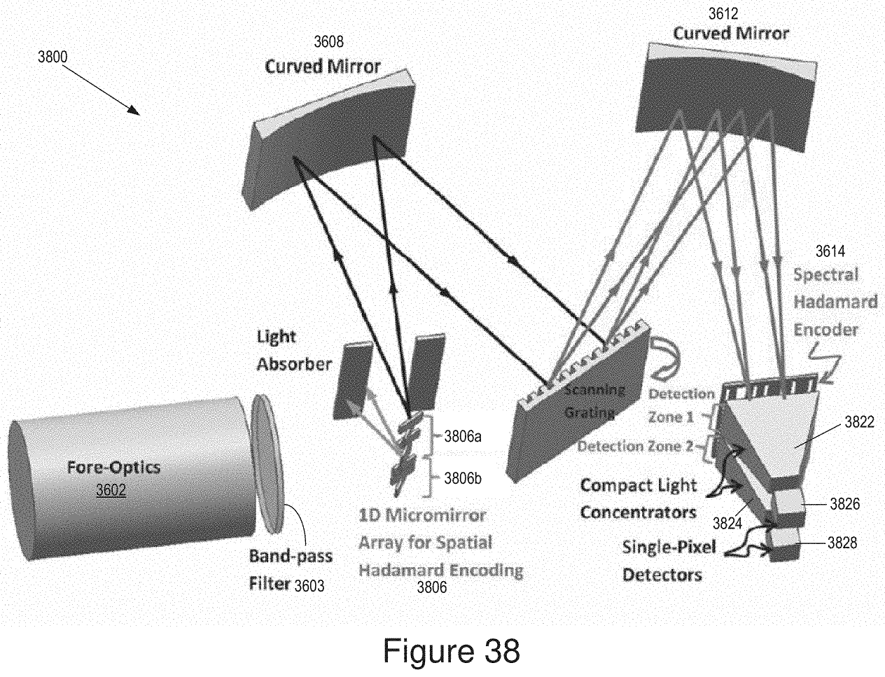

In some embodiments, a hyperspectral imaging sensor may employ multiple single-pixel photodetectors. This results in a compact sensor having an increased spatial resolution by N-fold with only a minimal or no increase in package size. A schematic diagram of such a system 3800 is shown in FIG. 38. The optical system is standard and remains unchanged, and the difference in design here is on the hyperspectral image detection plane. In the system 3800, the slit or micromirror array 3806 is divided into N segments and the image plane is then mapped into an equal number of detection zones accordingly. Each detection zone is associated with a light concentrator and a single-pixel photodetector. Accordingly, a first detection zone will receive signal from a first segment 3806a of the slit or array 3806, and this will be concentrated by light concentrator 3822 into a first single pixel photodector 3826. Similarly, a second detection zone will receive signal from a second segment 3806b of the slit or array 3806, and this will be concentrated by a second light concentrator 3824 into a second single pixel photodector 3828. The respective photodetectors 3826 and 3828 therefore record a hyperspectral image of the corresponding segment 3806a, 3806b of the slit or micromirror array 3806. All detection zones can share the same spectral encoding mechanism with the same Hadamard mask and rotational grating 3610. Such a design can be extremely compact and the detection zones can be placed one immediately after another with negligible gaps. In this way, using N separate single-pixel detectors, the spatial resolution is enhanced by N-fold without the necessity of increasing the overall size of the spectral/hyperspectral imager. Furthermore, it can also be shown that the required operation speed of the 2nd Hadamard encoder does not increase even though the overall sensor's spatial resolution increases by N-fold.

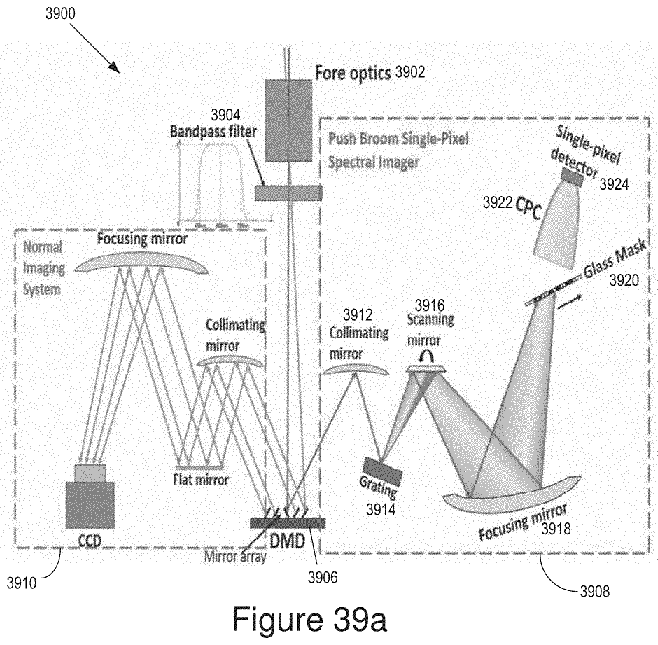

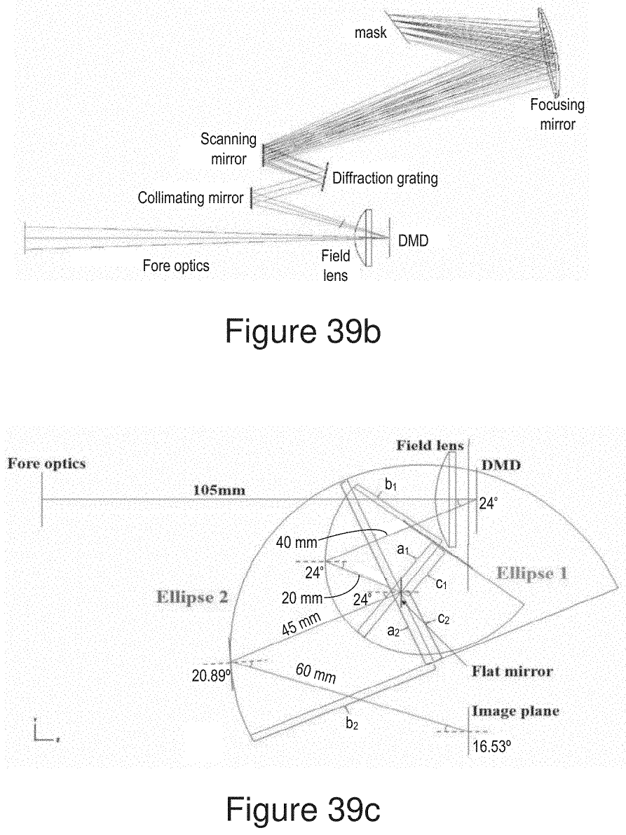

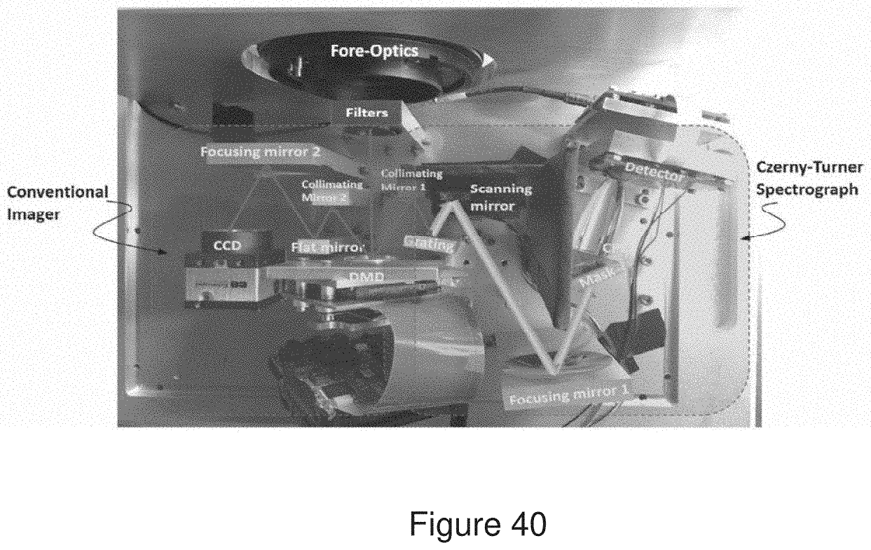

An example implementation of the embodiment of FIG. 37 will now be described. An example complete design layout is shown in FIG. 39, and a photo of the developed system is shown in FIG. 40. In one example, a commercially-available digital micromirror device (DMD) from Texas Instruments (TI) can be used as the micromirror 3706. As shown in FIG. 39a, after the object light is collected by the fore optics 3902, a bandpass filter 3904 is employed to limit the wavelength band entering the imaging system to between 450 nm and 750 nm. The DMD 3906 acts as the spatial encoding device and is placed after the wavelength filter 3904 and is located on the focal plane of the fore-optics 3902. The DMD (DLP7000) comprises a 1024×768 micromirror array, each element of which can be rotated in two directions (also named as open or close) to represent the encoding pattern ‘1’ or ‘0’ respectively. As shown in FIG. 39a, the image of the object on the DMD 3906 is separated into two parts by the micromirrors. When the selected micromirrors open (which stands for ‘1’), they reflect the light to a Czerny-Turner spectrograph system 3908. The rest of the micromirrors close (which stands for ‘0’) and reflect the light to a normal imaging system 3910. A column of micromirrors of the DMD 3906 may be used to emulate a slit. Those mirrors used for the slit will be opened or closed depending on the designated encoding patterns, while the rest of the micromirror elements not used for the slit will always be closed when in operation. The DMD 3906 has a high operating speed (up to 30 kHz) and the mirror direction can be monitored on the desktop, simplifying the synchronization process between the spatial encoding and spectral encoding. From the entrance slit on the DMD 3906, the light is reflected onto a diffraction grating 3914 by a collimating mirror 3912. The diffracted rays then reflect off a scanning mirror 3916 and a focusing mirror 3918 to form a dispersed slit image on a fixed glass mask 3920 with a Hadamard encoding pattern. The spectral encoding process is implemented by the scanning mirror 3916 and the fixed glass mask 3920. The light that passes through the mask 3920 is spectrally encoded, which is then collected by a light concentrator 3922 onto a single-pixel detector 3924. The single pixel detector 3924 will output voltage signals which depend on the brightness of the incident light.

A detailed ray-tracing diagram of the Czerny-Turner spectrograph 3908 from fore-optics 3902 to the mask 3920 when the DMD mirrors are in ‘1’ state is provided in FIG. 39b, while the details of the normal imaging system 3910 when the DMD mirrors are in ‘0’ state is illustrated in FIG. 39c with detailed design parameters highlighted. A photo showing the developed system with the key components annotated is provided in FIG. 40.

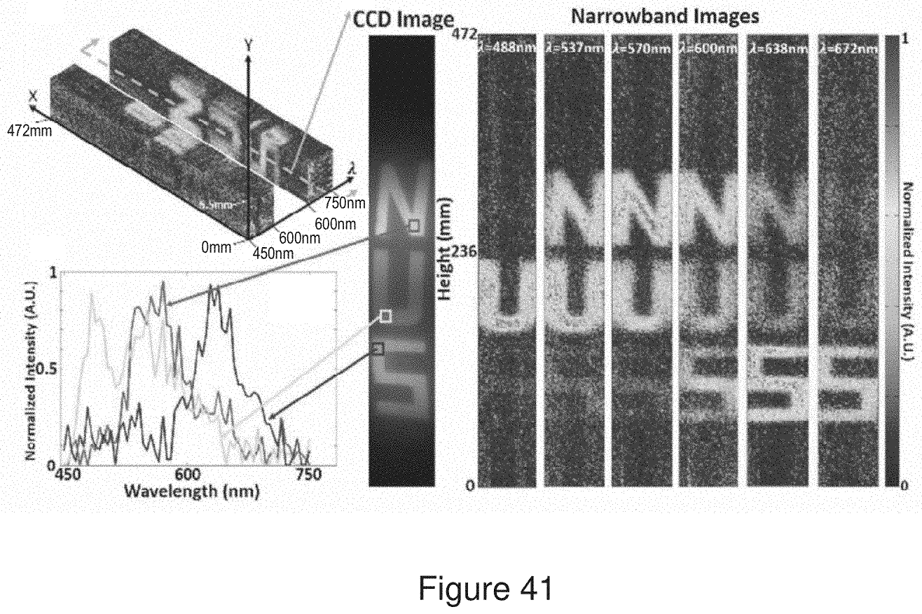

In one example experiment, three different coloured pieces of paper were used to make three letters, ‘N’, ‘U’ and ‘S’, as the object in the experiment. The object was tested under the illumination of a white LED light to demonstrate the imaging performance under reflected light. The object is located 4 meters away from the hyperspectral camera. As shown in FIG. 41(c), three letters were placed from top to bottom. Subsequently, the built-in CCD was used in the imaging system to take a picture as a reference to verify our experimental result. Because the single-pixel hyperspectral imager is operated under a pushbroom mode, the slit position on the DMD can shift horizontally, which allows the hyperspectral imager to capture a 3D hyperspectral data cube of the object without physically moving the imaging system or the object. This is an additional advantage to using the 2D micromirror array 3906. As shown in FIG. 41(a), the hyperspectral data cube has 359×63×45 pixels in the X (spatial), A (spectral), and Y (spatial) directions. The data cube was separated into two parts at 600 nm position in the A direction to see the image more clearly. FIG. 41(b) further shows the recorded spectra of three chosen points on the object. The three chosen points are respectively on green, blue, and red coloured letters, and the recovered spectra clearly exhibit wavelength characteristics of those three colors. FIG. 41(c) shows some narrow-band images of the object at 488, 537, 570, 600, 638, and 672 nm wavelengths. It can be seen that in the 488 nm wavelength image, the blue letter is visible and the rest are not. When the 537 nm wavelength image was taken, the green letter ‘N’ appears on the image and the intensity of this letter becomes stronger in the 570 nm wavelength image. Next, when the 600 nm wavelength image was taken, the red letter ‘S’ appears while the intensities of ‘N’ and become weak. When the wavelength is at 638 nm, the red letter ‘S’ shows the highest intensity. Finally, the image was taken at 672 nm, ‘N’ and almost disappear with only ‘S’ left on the image. These images clearly demonstrate the capability of the proposed single-pixel hyperspectral imager.

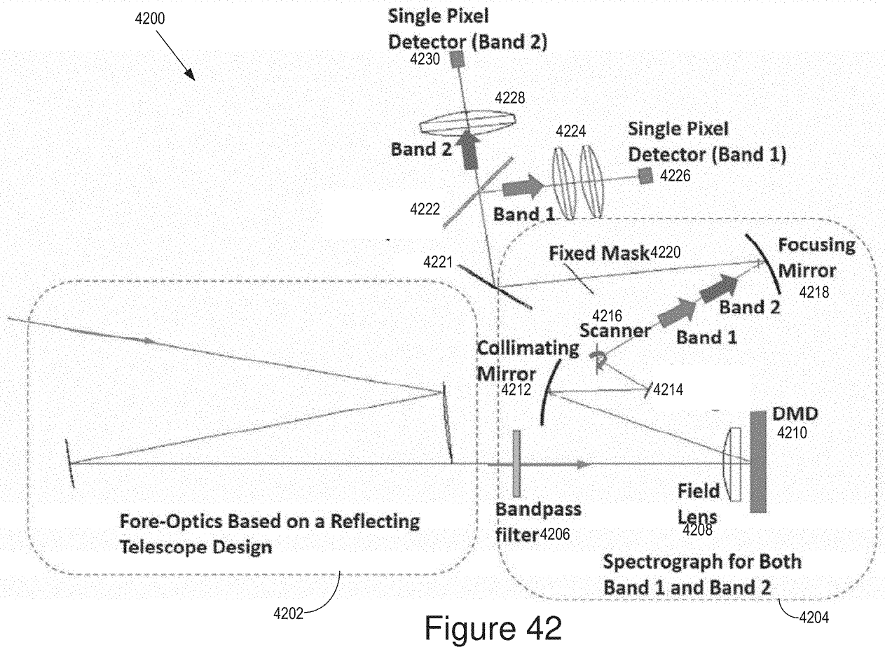

Another example system that further broadens the spectral band of the spectral/hyperspectral imaging system, and is capable of multiple-octave operation, will now be described with reference to FIG. 42. The system 4200 still enjoys the advantages of single-pixel detection technology. Conventionally, a spectrograph is suitable for operation in one octave of the spectral band. Larger than one-octave, higher diffraction orders will appear in the first order (i.e. the operation order), thus creating problems unless special filters are employed to filter out these higher diffraction orders.

The embodiment of the multi-octave hyperspectral imaging system 4200 shown in FIG. 42 employs a cascading scheme in the spectral dimension. The system 4200 uses a cascading of two single-pixel detectors 4226, 4230 to expand the operation band of the spectral/hyperspectral imaging system to two-octave. A two-octave embodiment is provided as an example, though it will be appreciated that this can readily be extended to multiple-octave operation (with a number greater than two) using multiple detectors.

In FIG. 42, a reflecting telescope system is used as the fore-optics 4202 to image the scene or object to the DMD 4210. Before the DMD 4210, a bandpass filter 4206 is used to pass the spectral bands of interest (i.e. band 1 and band 2) and reject the others. Here, band 1 spans one octave from 1λ to 2λ and band 2 also spans one octave from 2λ to 4λ. Band 2 is exactly twice the spectral wavelengths of band 1. With this design, the second diffraction order beams of band 1 from a diffraction grating 4214 have exactly the same paths as the first diffraction order beams of band 2 from the grating 4214. This characteristic allows us to design and optimize a single spectrograph 4204 for both band 1 and band 2 to operate simultaneously with high performance. The diffraction grating 4214 used in this spectral/hyperspectral imaging system 4200 can be blazed for the first diffraction order for band 2, and according to wave optics, the grating 4214 will automatically also be blazed for the second order of band 1.

The second order beams in band 1 and the first order beams in band 2 share the same spectrograph 4204 both with high diffraction efficiencies. Similarly, in the system 4200, the DMD 4210 is used for spatial encoding and the scanning mirror in combination with the fixed encoding mask 4220 is used for spectral encoding. After the two encoding processes, the beams exit the spectrograph 4204, and are subsequently reflected by a mirror 4221 (for folding the optical paths thus making the system compact), before they reach the wavelength band splitter 4222, where the rays of the two spectral bands separate and are collected by their respective collection optics 4224, 4228 and sent to their respective single-pixel detector 4226, 4230 for measurement and recording. Again, after a complete encoding cycle, the hyperspectral images of the object or scene for both band 1 and band 2 can be reconstructed therefore offering an expanded operational spectral band of the imaging system 4200.

Performing imaging through acquiring sequential aggregate intensities of the image field reduces the number of detectors. It allows utilizing only a single pixel photodetector. While requiring more time to acquire the whole image field, it has specific advantages: 1) low cost and potentially small form-factor; 2) can be operated in any wavelength band and is particularly attractive when the arrayed counterparts are too expensive or not readily available; 3) ease of calibration as inherently there is no array uniformity error. A Hadamard matrix pattern is one optimal set to configure the pattern of the image field.

Conventional ways of moving the Hadamard masks across the image field for encoding involve the use of electric motorized stages, rotating drums, and spinning wheels. These previous arrangements are large and unwieldy as some forms of electric motors and stages are needed to actuate the patterns. In addition, the image acquisition rate is slow due to the substantial mass/inertia of the conventionally fabricated Hadamard masks. Furthermore, the patterns and the actuating mechanisms for previous embodiments are also fabricated separately and post-assembled. This implies increased size, greater costs and more complicated alignment processes. At least some of the presently disclosed embodiments substantially obviate one or more of these limitations. Through the use of MEMS technology, the Hadamard mask patterns and driving actuators can be integrated on a common-chip platform, resulting in small, light-weight, low-inertia, and hence high-speed systems. Using the IC-like batch microfabrication processes, the imaging system can be potentially low-cost.

Embodiments of the invention simultaneously achieve high-speed and large-displacement scanning of Hadamard masks by attaching flexure suspensions to them and driving them in oscillatory motions at mechanical resonance. To further overcome the inherent stroke limitation of on-chip-integrated microactuators, in certain embodiments a 2-DOF vibratory system is implemented, where the microactuator acts as a primary driving system and the Hadamard mask takes the role of a secondary responding system. When driving the system at a suitable mode, a small vibration of the primary system (microactuator) can result in a large vibration amplitude of the secondary responding system (Hadamard mask).

Overall, embodiments of the present invention provide a low-inertia, high-speed, large travel range, and miniature system of generating Hadamard mask patterns for single-pixel imaging. The imager can hence achieve miniaturization and high SNR, yet maintaining all the benefits of having a single-pixel photodetector. The Hadamard masks and the actuating mechanisms are fabricated on a common-chip platform utilizing MEMS technology, which potentially ensures low-cost and makes any assembly and alignment processes unnecessary.

Embodiments of the invention may be useful in applications that require a miniature spectral imaging system. The system can be made extremely portable. Food industries are an area where this will be suitable. Portable hand-held spectral imagers would allow inspection to be performed on-site in real-time. This can be used to check the freshness or the quality of fresh produce, for example. Another application would be aerial imaging of ground terrain, particularly for unmanned aerial vehicles (UAVs) where there is limited payload. The spectral imager would allow the UAVs to be able to analyze and classify the objects as it is flying over. Potential applications of this air-borne spectral imaging system include mineral identification in geology, terrain classification and camouflaged target detection in defense systems, coastal and inland water studies, and environmental hazards monitoring and tracking.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A spectral imaging system comprising:
a spatial encoder comprising a first light encoding device comprising a first mask for spatial encoding, the first mask being configured with one or more encoding patterns;
a spectral encoder comprising:
a dispersion arrangement for splitting spatially encoded light from the first light encoding device into a plurality of components; and
a second light encoding device comprising a second mask for spectral encoding of the plurality of components, the second mask having one or more encoding patterns; and
at least one single-pixel photodetector positioned to measure light that is encoded by the masks;
wherein the spatial encoder is operable to spatially encode light by generating a sequence of different patterns or partial patterns of the one or more encoding patterns of the first mask; and
wherein the spectral encoder is operable to spectrally encode light by relative movement between the dispersion arrangement and the second mask.

2. The spectral imaging system according to claim 1, wherein the spatial encoder comprises a window structure comprising at least one aperture that is positionable in line with the first light encoding device to selectively expose at least part of the one or more encoding patterns of the first mask, and wherein the first mask is movable relative to the at least one aperture in oscillatory fashion.

3. The spectral imaging system according to claim 2, wherein the at least one aperture is also positionable in line with the second light encoding device to selectively expose at least part of the one or more encoding patterns of the second mask, and wherein the second mask is movable relative to the at least one aperture in oscillatory fashion.

4. The spectral imaging system according to claim 1, wherein the first mask is a dynamic mask that is operable to generate said sequence of different patterns.

5. The spectral imaging system according to claim 4, wherein the dynamic mask comprises a MEMS programmable slit or a digital micromirror device.

6. The spectral imaging system according to claim 1, wherein the dispersion arrangement comprises an optical band-pass filter and a diffraction grating, and wherein the diffraction grating is configured for oscillatory rotation.

7. The spectral imaging system according to claim 1, wherein the dispersion arrangement comprises an optical band-pass filter and a fixed-position diffraction grating that is optically coupled to a scanning mirror that is configured for oscillatory rotation.

8. The spectral imaging system according to claim 1, comprising a plurality of single-pixel photodetectors, wherein at least one mask comprises a plurality of zones, respective zones being associated with respective ones of the plurality of single-pixel photodetectors.

9. A light encoding device for generating an encoding pattern for an imaging process, the light encoding device including:
one or more oscillators; and
a mask coupled to the one or more oscillators, the mask having one or more patterns each comprising opaque and transparent sections;
wherein the one or more oscillators are operable to move the mask across an aperture to selectively expose at least part of said one or more patterns through the aperture to thereby generate the encoding pattern.

10. The light encoding device of claim 9, wherein a first oscillator of the one or more oscillators is coupled to a second oscillator of the one or more oscillators by an auxiliary mass.

11. The light encoding device of claim 9, configured to receive a driving force in a direction substantially parallel to an oscillation direction of at least one of the one or more oscillators, and/or in a direction substantially perpendicular to an oscillation direction of at least one of the one or more oscillators.

12. The light encoding device of claim 9, comprising a plurality of patterns.

13. The light encoding device of claim 12, wherein the mask is a Hadamard mask.

14. The light encoding device according to claim 9, wherein the one or more oscillators are coupled to one or more respective support structures.

15. The light encoding device according to claim 14, wherein at least one of the support structures is fixed.

16. The light encoding device according to claim 9, wherein at least one of the oscillators is coupled to a gimbal, the gimbal being coupled to a gimbal suspension oscillator.

17. The light encoding device according to claim 9, wherein the mask is coupled to at least one oscillator configured to oscillate in a first direction, and at least one oscillator configured to oscillate in a second direction that is orthogonal to the first direction.

18. (canceled)

19. An imaging system, comprising:
one or more light encoding devices according to claim 9;
a window structure comprising at least one aperture that is positionable in line with the one or more light encoding devices to selectively expose at least part of the one or more patterns of the mask or masks, the window structure also being positionable in line with an object or a light source;
one or more actuators to cause relative movement between the mask or masks and the at least one aperture; and
at least one single-pixel photodetector positioned to measure light from the object or the light source that is encoded by, and transmitted through, the mask or masks.

20. The imaging system according to claim 19, comprising one or more position sensors to monitor a position of the mask, or respective positions of the masks.

21. The spectral imaging system according claim 1, wherein at least one of the first light encoding device and the second light encoding device is a light encoding device which includes:
one or more oscillators;
a mask coupled to the one or more oscillators, the mask having one or more patterns each comprising opaque and transparent sections; and
wherein the one or more oscillators are operable to move the mask across an aperture to selectively expose at least part of said one or more patterns through the aperture to thereby generate the encoding pattern.
